(19) United States
(12) Patent Application Publication
(10) Pub. No.: US 2002/0138400 A1
(43) Pub. Date: Sep. 26, 2002

(54) Buying and selling goods and services using automated method and apparatus

(76) Inventors: Louise J. Kitchen, Houston, TX (US); Jay C. Webb, Houston, TX (US); Marcello Romano, London (GB)

Correspondence Address: Stephen S. Hodgson, Vinson & Elkins L.L.P., 2300 First City Tower, 1001 Fannin, Houston, TX, 77002-6760, US

(21) Appl. No.: 09/895,092

(22) Filed: Mar. 22, 2002

Related U.S. Application Data
(60) Provisional application No. 60/215,471, filed on Jun. 30, 2000.
(60) Provisional application No. 60/218,473, filed on Jul. 14, 2000.

(51) Int. Cl. G06F 17/60

(52) U.S. Cl. 705/37

(57) ABSTRACT

A method and system are provided for a party to buy and sell goods and/or services from and to a plurality of counterparties over a computer network. The party determines a best bid price and a best offer price at which the party is willing to buy or sell a good or service. The party transmits the best bid and offer prices over the computer network, which may be the internet. By accessing the computer network, a counterparty can see a display of a bid and offer price for the good or service. The counterparty can click on the display to send a signal over the computer network to the party, and upon receipt of the signal, the party can buy the good or service from or sell the good or service to the counterparty. The method preferably includes maintaining a list of determined bid and offer prices in a stack manager software, which allows the party to automatically display a next best bid and offer price to the counterparties over the computer network after a transaction is completed.

### CROSS-REFERENCE TO RELATED APPLICATION

Priority and benefit is claimed to U.S. Provisional Patent Application Serial No. 60/215,471, filed on Jun. 30, 2000, and No. 60/218,473, filed on Jul. 14, 2000, and both of these provisional patent applications are incorporated by reference for all purposes.

### BACKGROUND OF THE INVENTION

This invention pertains to buying and selling goods and services over a computer network using a semi-automated system. Buying and selling of some goods and services has been conducted in recent years through negotiations conducted directly between the parties to such transactions, or through brokers or other intermediaries acting as agents on behalf of the parties to such transactions. The manner in which transactions have been negotiated and completed have varied accordingly.

In direct negotiations, the parties exchange information and negotiate the terms and conditions of the proposed transaction, often through written correspondence or telephone conversations. In many cases, the availability of a particular good or service and the terms and conditions upon which a party may be willing to enter into a transaction with respect to that good or service cannot be determined without substantial effort. Depending on the particular good or service and the terms upon which a party may be willing to transact, the transaction negotiation and completion process can be labor-intensive and time consuming. These factors may ultimately limit the number of transactions that a party can successfully negotiate and complete.

In addition, the costs associated with transacting in this manner can be exorbitant as a result of the time required to negotiate, document, account for, and monitor individual transactions, many of which may have been completed on terms and conditions varying significantly from transaction to transaction; the time associated with identifying errors and resolving disputes between parties that occasionally result from miscommunications between the parties; and, in some cases, changes in pricing and other economic terms that occur before transactions are completed. For instance, prices of some products may change within minutes, let alone the hours or days that it may take to negotiate and complete transactions, and a potentially profitable transaction can become unprofitable even before it is completed.

Conducting transactions through brokers or other intermediaries, including on markets or exchanges, does eliminate some of these disadvantages. Many goods and services that are traded in this manner have uniform attributes or characteristics, which eliminates negotiations on product specifications and quality; negotiations and transactions are completed according to trading rules established by the marketplaces, which facilitates negotiation and execution of deals; and in many cases, the prevailing, or “market,” prices at which parties are willing to transact in goods and services are published or otherwise readily available to those interested in transacting in those goods and services, eliminating the need to negotiate price. This general availability of information and certainty as to terms facilitates a more efficient marketplace in which less time is required to discover and negotiate terms, more transactions may be completed, and transactions costs can be reduced. However, stock markets, commodity exchanges and brokerage houses usually insert a middleman, typically a broker, between the buyer and the seller that charges a fee or a commission to complete the transaction. In fact, access to many markets and exchanges may be obtained only by using a broker.

With the advent of the internet, it has become possible to conduct business electronically over a network of computers. The internet is a system of many computers from around the world linked together via wires, cables, satellites and wireless communication links. Electronic mail, or “e-mail”, can be sent from one user at one computer to another user at a different computer. However, it is the worldwide web, which is a system for sending graphical web pages of information from one computer to another, that has spurred the growth of the internet to include millions of users. The worldwide web facilitates not only communications, but also commerce between businesses and consumers, and commerce among businesses and other businesses (otherwise referred to as business-to-business, or “B-to-B” or “B2B” commerce).

With the worldwide web, a customer's computer system can display web pages in a website, which provides a means for a business to advertise its goods and services to that customer. A uniform resource locator (“URL”) provides a uniquely identifiable address for each computer and web page on the internet. Web pages can be requested and accessed using hypertext transfer protocol (“HTTP”) for navigating the worldwide web on the internet. A customer's request for a web page is forwarded to a web server, which sends the web page to the customer's computer system, which displays the web page to the customer using a browser. The browser enables the display of the web pages to the customer.

Electronic commerce conducted over the internet has progressed significantly in recent years. For example, Amazon.com, Inc., which has grown into a major corporation, began by selling books to consumers over the internet with physical delivery of the books completed by a delivery service. U.S. Pat. No. 5,960,411 is assigned to Amazon.com and describes a method and system for placing a purchase order via a communications network. The patent describes how a consumer can “click” on a “button” in a website in order to place an order for an item. U.S. Pat. No. 6,058,379, assigned to Auction Source, L.L.C., is entitled as a real-time network exchange with seller-specified exchange parameters and interactive seller participation. The patent describes the electronic exchange of goods and services via an electronic network. It is said that sellers and buyers access the exchange to list items and bid on listed items via client terminals. It is said that an individual is empowered to circumvent third parties to ensure that an exchange is as fair as possible. Users of the system include sellers that list items to be sold and buyers who can access the list of items for sale and can buy an item.

U.S. Pat. No. 5,845,265, assigned to MercExchange, L.L.C., is entitled as consignment nodes and is said to describe a method and apparatus for creating a computerized market for used and collectible goods. The abstract states that a plurality of low-cost posting terminals and a market maker computer are used in a legal framework that establishes a bailee relationship and consignment contract with a purchaser of a good.

U.S. Pat. No. 5,724,524, assigned to Pitney Bowes, Inc., is entitled as a method and system for listing, brokering, and exchanging carrier capacity. It is said that the invention is a method and system for listing and brokering a commodity and its financial derivative. It is said that a plurality of characteristics of a particular commodity can be entered into a data processing system. It is further stated that financial derivatives can be established and that with the establishment of derivatives classes, a financial exchange market for those derivatives can be established.

U.S. Pat. No. 5,794,207, assigned to Walker Asset Management Limited Partnership, is entitled as a method and apparatus for a cryptographically assisted commercial network system designed to facilitate buyer-driven conditional purchase offers. The patent purports to allow prospective buyers of goods and services to communicate a binding purchase offer globally to potential sellers, for sellers to search for relevant buyer purchase offers, and for sellers potentially to bind a buyer to contract based on the buyer's purchase offer.

The above-described U.S. Pat. Nos. 5,960,411; 6,058,379; 5,845,265; 5,724,524; and 5,794,207, which are hereby incorporated by reference for all purposes, thus provide examples of commerce that has been conducted over the internet. As indicated by these patents, electronic commerce over the internet has progressed substantially since the inception of the internet. However, there remains a need for a more efficient marketplace for buying and selling goods and services.

### SUMMARY OF THE INVENTION

The present invention provides a method, apparatus, software and/or system for a party to buy and/or sell goods and/or services over a computer network. Using the invention, one may effectively establish a market in a product by determining the price at which one is willing to buy a good or service, also referred to as a “bid” price, and the price at which one is willing to sell the good or service, also referred to as an “offer” price. These predetermined bid and offer prices for the good or service are transmitted over a computer network, such as the internet or a private computer network, and displayed to a party that is interested in considering a transaction in the good or service. The party receiving the information can choose to sell or buy the good or service, typically at the bid or offer price transmitted by the first party. The only parties involved in the transaction are the first party establishing and transmitting the prices, and the second party that receives them and decides to buy or sell the good or service; the transaction is not completed on any third-party exchange, no broker or middleman is involved, and no commissions are paid to any third party.

For purposes of the description of the invention, the party that uses the system to establish and transmit to other parties prices at which it is willing to purchase or sell goods and services is referred to as the “Party,” and the parties who receive such information and who may elect to enter into transactions with the Party based upon such prices are referred to as “Counterparties.” Parties and Counterparties may have employees or agents that use the system for entering into transactions on behalf of their employer/principal, which employees or agents are sometimes referred to as “traders.” The goods and services that are available for purchase and sale through the system are referred to as “products;” while that term may imply tangible goods, such as natural gas, it also includes intangible goods or services, including financial products, natural gas pipeline capacity, or bandwidth.

In one embodiment, an application that is referred to as a “stack manager” software module enables the Party to create and maintain a list, or what is referred to as a “stack,” of the Party's predetermined bid and offer prices for a product, and each of these prices can be associated with a predetermined volume of the product that the Party wishes to purchase or sell at that price. All potential Counterparties viewing the website see only a single bid price and a single offer price for a product, which is the Party's best bid and offer price for that product, and all potential Counterparties see the same bid price and the same offer price for that product. The system provides for a Counterparty's purchase or sale of a product at the displayed bid price or offer price, and after completion of that transaction at that displayed price, the stack manager software immediately (but not instantaneously) provides the next set of predetermined bid prices and offer prices from the stack for that product, which are transmitted over the computer network and displayed to potential Counterparties as the next available transaction. This system of continuously displaying products available for purchase or sale at displayed prices essentially provides for a continuously operating market for the product, where the Party is always willing to buy at the bid price or sell at the offer price displayed for the product.

Certain elements of the stack manager enhance the efficiency of the market created by the Party. The stack manager software module can be used by a Party to effect a relatively simple trading strategy by establishing a list, or “stack,” of predetermined bid and offer prices for a series of transactions that can be executed in an automatic fashion; or may also be used to effect more complex trading strategies by linking one list, or “stack,” of bid prices and offer prices to another list, or “stack,” of bid prices and offer prices. In another embodiment of the invention, a Party can provide for an automated reset of its bid price and offer price that adjusts the displayed bid price and/or offer prices based on the prices at which other transactions in that product have been completed. Thus, the Party can establish an automated means for changing the displayed bid and offer prices of a product, all of which enhances the Party's ability to make a market in a product by being able to efficiently complete a substantial number of transactions.

Other aspects of the invention facilitate a Counterparty's ability to quickly and efficiently enter into transactions with the Party via a computer network. In one aspect of the invention, a step is provided for establishing a credit limit for a Counterparty and monitoring the Counterparty's remaining credit as transactions with the Party are executed. The method may further include suspending trading with a Counterparty when the established credit limit is reached. In another aspect of the invention, the method provides for a simplification of the process by which a contract for the purchase or sale of products is formed between the Party and the Counterparty.

In another aspect, the present invention enhances a Party's ability to quickly bring new products to the Party's online marketplace by establishing a standardized set of attributes and parameters for identifying and describing products that the Party is willing to buy or sell. Preferably, what is referred to as “product manager” software allows the Party to combine attributes and parameters identifying and describing the product to potential Counterparties to quickly and efficiently communicate to the potential Counterparties those products that the Party is willing to buy or sell. This also permits the Party to quickly and efficiently add new products to its website offering.

In summary, the present invention allows a Party to enter into transactions with many Counterparties for many products using automated means over a computer network. As demonstrated in more detail below, the system permits a Party to substantially increase the number of transactions that can be completed in a particular period of time and potentially reduce associated transaction costs, and is of particular benefit to a Party that is actively engaged in the business of “trading” a product, the success of which business often depends upon reliable market information and rapid completion of numerous transactions. While the present invention is not directed to transactions between Counterparties (that is, the Counterparties may not enter into transactions with other Counterparties using the invention, but only with the Party), components of the present invention may be useful in an “exchange” or counterparty “matching” environment where a participant is not limited to entering into transactions with the single party that is operating the system on its own behalf, but may enter into transactions with any other participant that accesses the system.

### BRIEF DESCRIPTION OF THE DRAWINGS

The present invention can be more easily understood with reference to the drawings, in which:

FIG. 1 provides a block flow diagram illustrating the initial steps of a Counterparty accessing the website, becoming authorized to enter into transactions via the website, and submitting an offer to the Party to buy or sell products, according to the present invention;

FIG. 2 is a screen print of a display of the “quotes page” in which products available for purchase or sale and their corresponding bid prices and offer prices and volumes may be viewed by a Counterparty, according to the present invention;

FIG. 3 is a block flow diagram of additional steps involved in entering into a transaction for the purchase or sale of products, according to the present invention;

FIG. 4 is a screen print of a “submission box”, or a display that a Counterparty can use to submit an offer to the Party to buy or sell a product, according to the present invention;

FIG. 5 is a screen print of a display of a Counterparty's transactions that have been completed with the Party via the website that a Counterparty can view, according to the present invention;

FIG. 6 is a block flow diagram illustrating the addition by the Party of a new product that can be purchased or sold via the website, according to the present invention;

FIG. 7 is a screen print of a display that a Party can use to add a product that can be purchased or sold via the website, according to the present invention;

FIG. 8 is a screen print of a display that a trader can use for reviewing and editing the attributes or parameters related to a product, according to the present invention;

FIG. 9 is a block flow diagram showing steps for managing a product with stack management software, according to the present invention;

FIG. 10 is a screen print of a display that a trader can use for interacting with stack manager software, according to the present invention;

FIG. 11 is a screen print of a display that a trader can use for interacting with stack manager software, according to the present invention;

FIG. 12 is a screen print of a display that a trader can use for interacting with stack manager software, according to the present invention;

FIG. 13 is a screen print of a display that a trader can use for interacting with stack manager software, according to the present invention;

FIG. 14 is a block flow diagram illustrating links that can be made between lists of predetermined prices, or “stacks”, according to the present invention;

FIG. 15 illustrates method steps for managing price resets through the stack manager, according to the present invention;

FIG. 16 illustrates the steps for linking one stack to another to mitigate foreign exchange risk that exists when the underlying product is to be offered in a currency other than the currency in which the product is normally traded, according to the present invention;

FIG. 17 is a screen print of a display that a trader can use for interacting with stack manager software in order to mitigate foreign exchange risk associated with a product, according to the present invention;

FIG. 18 is a screen print of a display that a trader can use for interacting with stack manager software in order to mitigate foreign exchange risk associated with a product, according to the present invention;

FIG. 19 is a block flow diagram illustrating steps for managing credit exposure to a particular Counterparty, according to the present invention;

FIG. 20 illustrates one possible configuration of hardware for operating software that allows for buying and selling goods and/or services over a computer network, according to the present invention.

### DETAILED DESCRIPTION OF THE INVENTION

Introduction. This invention pertains to buying and selling goods and services over a computer network using a semi-automated system. Although the invention may be useful for facilitating the purchase or sale of practically any good or service, certain aspects of the invention make it particularly useful to a Party that is engaged in the business of buying and selling, or “trading,” large volumes of products, entering into a large volume of transactions for such products, or both, as a principal for its own account. While certain aspects of the invention may be useful to an intermediary that merely introduces or “matches” counterparties seeking to enter into a transaction, to “brokers” who arrange and complete transactions for third parties for a fee, or to a number of counterparties that wish to engage in a variety of transactions with each other such as occurs on an “exchange,” the present invention contemplates a single party using the invention to enter into transactions as a principal for its own account with multiple counterparties.

Many of the examples used in the description of the invention below illustrate the use of the invention in the business of trading energy and energy-related products. As will be seen in this description of the invention, however, the potential uses of the invention are not limited to any particular product; however, the invention is particularly useful to facilitate the trading of products in markets that are highly developed, highly volatile, populated with a substantial number of complicated or sophisticated products, and/or populated with a large number of sophisticated potential counterparties.

Background. In the recent past, trading in many types of products such as natural gas, electricity, crude oil, cracked distillate products, metals, forest products, precious stones and minerals, agricultural products and other commodities has been conducted largely over the telephone or through organized markets or exchanges. A trader that bought and sold such products relied extensively upon the telephone and personal contact between the trader and his or her customers or brokers for information regarding the available markets for particular products; a substantial portion of trades was negotiated between the party and their counterparty, or was completed between a party and its broker. Up-to-date information on the market for the particular product was important in order to complete a transaction, and a trader's productivity depended to a great extent on the trader's ability to negotiate a substantial number of transactions quickly and efficiently and on favorable terms.

As markets for certain products became more developed, market liquidity (that is, buyers and sellers willing to transact and volumes available for purchase and sale) increased, customers became more sophisticated, products became more complicated, and market prices and trading volumes demonstrated greater degrees of volatility. For example, the natural gas and electricity markets have become increasingly volatile in recent years, with product prices and product availability changing in seconds, and often in great orders of magnitude. These markets have also become increasingly competitive with the addition of a substantial number of market participants. In this environment, a trader's productivity and profitability can depend heavily upon having access to timely and reliable information regarding the market in which the trader is trading, and being able to enter into a large volume of trades quickly. Also, a company that trades a large volume of products can be in a unique position to make a market in those products provided that it can meet the demands of the other participants in the market, such as immediate access to reliable information regarding the market and efficient execution of transactions.

Natural gas and electricity traders have typically used various combinations of the telephone, facsimile, e-mail, and proprietary trading networks to complete transactions. These methods allowed a party to communicate and negotiate with a single counterparty, but did not give a party access to the broader market (several potential counterparties at one time). Exchanges provided a party with access to the broader market, but often required use of an intermediary that charged a commission. It is believed that prior to this invention there was no concentrated marketplace on a computer network for the trading of commodities such as electricity and natural gas directly between a large number of potential buyers and sellers without the need for a broker to facilitate the transactions.

With the present invention, a market can be established for any product (either a good or a service). The present invention provides a set of tools that traders can use to disseminate information to multiple potential counterparties regarding a product, buy or sell that product over a network of computers, and assist a trader in entering into transactions quickly and efficiently over a computer network, all without the need for personal contact with a customer for each and every transaction and without the need for a third-party intermediary or broker to introduce the party and counterparty in exchange for a commission. The network of computers is presently envisioned as the internet, but it is recognized that the internet will evolve in ways not yet foreseen, and a proprietary network can be used as well.

Introduction to the Figures. Turning now to the figures, one embodiment of the present invention is set forth for trading in products over the internet, where the Counterparty has access to a website on the internet. The Party provides and maintains the internet website, which in current technology uses the worldwide web. The figures first illustrate those aspects of the invention that are visible and apparent to the Counterparty, including a system providing for (i) a Counterparty's initial access to the system, (ii) a Counterparty becoming appropriately “qualified” to transact via the system, and (iii) a Counterparty entering into transactions with the Party through the system. The figures then illustrate those aspects of the invention that are not visible to or accessible by the Counterparty, but are visible to and used by the Party to provide for (i) the Party placing a product on the website to make it available for purchase or sale, and (ii) the Party determining prices and volumes of products available for purchase and sale and thereby making the Party's “market” for those Products, and (iii) the Party's management of the various products that are available for purchase and sale on the website.

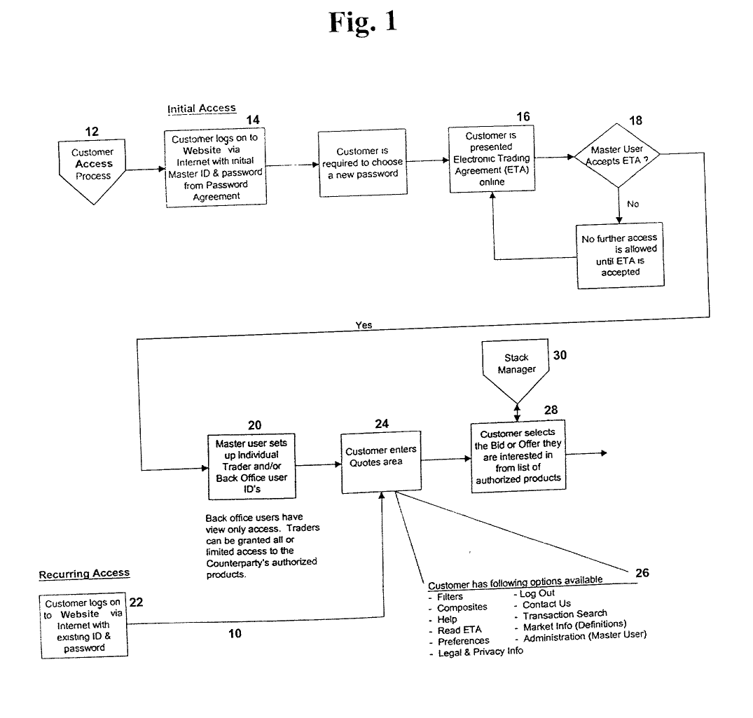

Establishing Access to the Website. With reference to FIG. 1, a process flow 10 is set forth according to the present invention. In step 12, a potential Counterparty accesses a display of a website that is transmitted by the Party. In the current embodiment, any person with access to the internet can see the initial display of the website, which may contain general information about the Party and the website, as well as instructions for utilizing the website. However, in order to access those portions of the website from which the Counterparty may actually view available products and prices and propose to enter into transactions with the Party (a process referred to as “logging on” to the website), in one embodiment a contractual framework for transactions to be entered into through the trading system is established before the Counterparty may “log on” to the website. In the current embodiment, this contractual framework includes (i) a password application, in which a potential Counterparty obtains a unique identifier that permits such potential Counterparty to access the trading functions of the website, (ii) an electronic trading agreement, in which the Counterparty agrees to general terms and conditions of use of the website and the manner in which contracts for transactions completed on the website are formed, and (iii) the terms and conditions that will govern actual transactions in particular products, which in the current embodiment are either in the form of general terms and conditions (“GTCs”) that are available to any Counterparty or, alternatively, a master agreement specifically negotiated between the Party and the Counterparty, if such an agreement exists between the Party and the Counterparty. Alternative contractual frameworks can be used.

The password application (“PA”) is a one-page document conformed to the applicable laws of the country from which the Counterparty is trading, and is the only document which must be manually executed by the Counterparty (as opposed to any of the other agreements or documents, which may be accepted online by “clicking” as described below). A conventional ink (wet) signature can be used, although an electronic signature may become typical. The PA is the document by which the Counterparty (i) requests a “master user ID” and password, which are identifiers that are unique to that Counterparty and that permit the Counterparty to access the system, (ii) agrees to keep the master user ID and password secure, and (iii) agrees to be bound by any agreement displayed on the website to which the Counterparty signifies its agreement by “clicking” on the designated spaces in the agreement, including the ETA and any transaction completed as the result of the Counterparty “clicking” on a price displayed on the website. Because the PA establishes the Counterparty's agreement to be legally bound to any agreement that is made on the website through “clicking”, the Party should confirm that the PA has been executed by an agent of the Counterparty that is authorized to enter into such agreements on behalf of the Counterparty to ensure that agreements entered into online by “clicking” have been legally authorized by the Counterparty.

As used in this description, “clicking” on an agreement that is transmitted and displayed to a Counterparty on the website is meant to describe the process by which the Counterparty indicates its agreement to or acceptance of the terms of that agreement (and thus creating an “online agreement”) by sending an electronic signal to the Party over the internet; similarly, “clicking” on a price that is transmitted and displayed to a Counterparty on the website is meant to describe the process by which the Counterparty indicates its selection of that price by sending an electronic signal to the Party over the internet.

The PA allows the Counterparty to obtain what is referred to as a “master user ID,” which allows the holder of the master user ID (the “master user”) to grant access to the website to others within the master user's organization (sometimes referred to as “sub-users”), to control the sub-users' access to particular products or functions on the website, and to monitor and control the subusers' and the Counterparty's overall transaction activity on the website.

Upon a master user's first log-in to the website in a step 14 (see FIG. 1), the electronic trading agreement (the “ETA”) is displayed online to the master user in a step 16. The ETA, like the PA, is conformed to the laws of the country in which the Counterparty is transacting via the website, and, among other things, establishes a contract between the Party and the Counterparty with respect to the use of the website, the process in which a legally valid and binding contract for purchase or sale of a product may be created through the website (which is discussed in more detail below). The ETA may also include representations, warranties, covenants, provisions regarding execution of transactions, limitations of liability, indemnities and confidentiality provisions similar those typically included in standard commercial arrangements, and other rules for entering transactions through the website to, among other things, reflect particular market or industry customs and practices.

The master user agrees, on behalf of the Counterparty, to the ETA in a step 18 in order to continue using the website and in order to authorize any sub-users to use the website. The master user indicates the Counterparty's agreement to the ETA by “clicking” on a designated space on the ETA indicating the master user's acceptance of the ETA. The Counterparty agrees to, or “accepts”, the ETA once; i.e. if the master user has accepted the ETA, neither the master user nor his sub users are required to agree to it at any later time, as the ETA provides that the Counterparty and everyone transacting on behalf of the Counterparty are thereafter bound by it.

The master user grants access to the website on behalf of the Counterparty to sub-users in a step 20. Master users have the authority to create sub-users who have trading rights on the system on behalf of the Counterparty, or sub-users who are only back office users that are only able to view transactions that users with trading rights have completed and that do not have rights to enter into transactions. The philosophy behind issuing master user IDs is to allow Counterparties to control their own users within the limits of the overall rights granted to the master user.

Steps 14-20 apply to a Counterparty's first access to the website. Afterwards, as indicated in a step 22, a Counterparty may “log on” to the system using his ID and password, and is ready to enter the “quotes” area to view the products available for purchase and sale and to potentially enter into transactions.

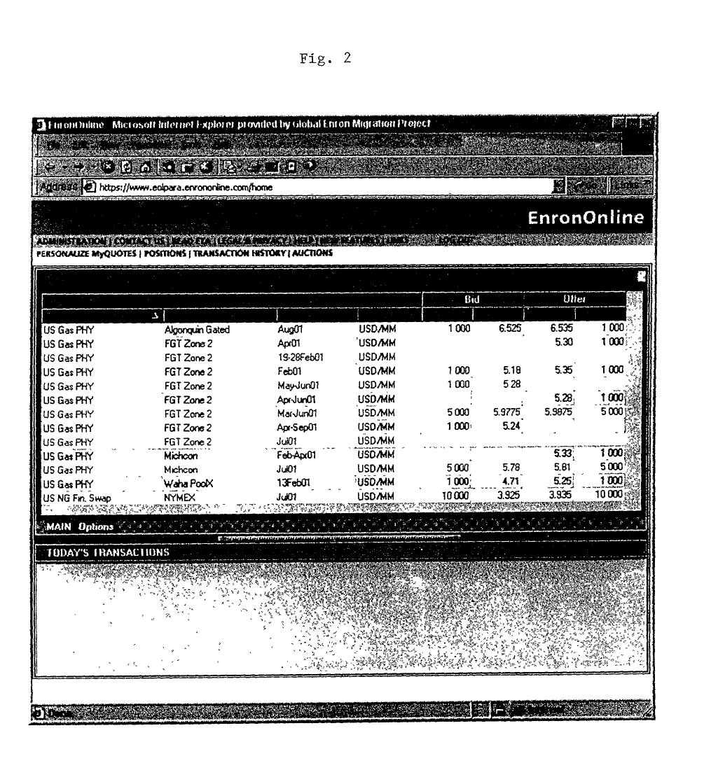

Entering into Transactions through the Website. After logging on to the system, a Counterparty may enter into what can be referred to as the “quotes page” in order to buy or sell from or to the Party (step 24). Transactions are initiated by the Counterparty from the quotes page, which is the “core” page of the website from the Counterparty's perspective; a sample quotes page is shown in FIG. 2. The quotes page shows a listing of all the products that the Counterparty can view (identified by the product short description, discussed in more detail below) and all the products in which the Counterparty may transact (all of which can be established, controlled, and monitored by the master user), as well as the bid prices, offer prices and associated volumes that the Party is currently displaying for each of those products.

In the quotes page (step 24), the Counterparty has a number of options for customizing his view and navigation of the quotes page, including creating filters that strain out information that he does not want to view and composites that aggregate information that he does want to see, for the purpose of organizing and displaying only those products that are of interest to the Counterparty. Products can be filtered by country, region, deal type, commodity, currency or category. Once filters are created, the results can be saved into sections named by the Counterparty and located within composite pages, and the composite pages can be named by the Counterparty as well. Counterparties can create multiple sections within multiple composite pages. By combining the individual products and filters, many products can be displayed in small groups. As indicated in step 26, the Counterparty can also search for information and read various notices.

As indicated in step 28 in FIG. 1, in order to offer to enter into a transaction with a Party for a particular product, a Counterparty need only “click” once on the bid or offer price shown on the quotes page for that product in order to create an offer to purchase that product from or sell that product to the Party at that price, and then “click” once again on the submission box (described below) in order to confirm the submission of the Counterparty's offer (the significance of the Counterparty submitting an “offer” to enter into a transaction is described in more detail below). However, Counterparties may also obtain more information prior to submitting their offer to the Party, including the product long descriptions (discussed in more detail below) and general terms and conditions that apply to that product, the market hours (the hours during which the Party is operating an online market for that product), and contact details for the Party's trader that is responsible for maintaining the market in that particular product. A stack manager software 30, which is explained in detail below, continually “feeds” the Party's bid prices, offer prices, and associated volumes to the website for display to the Counterparty on the quotes page.

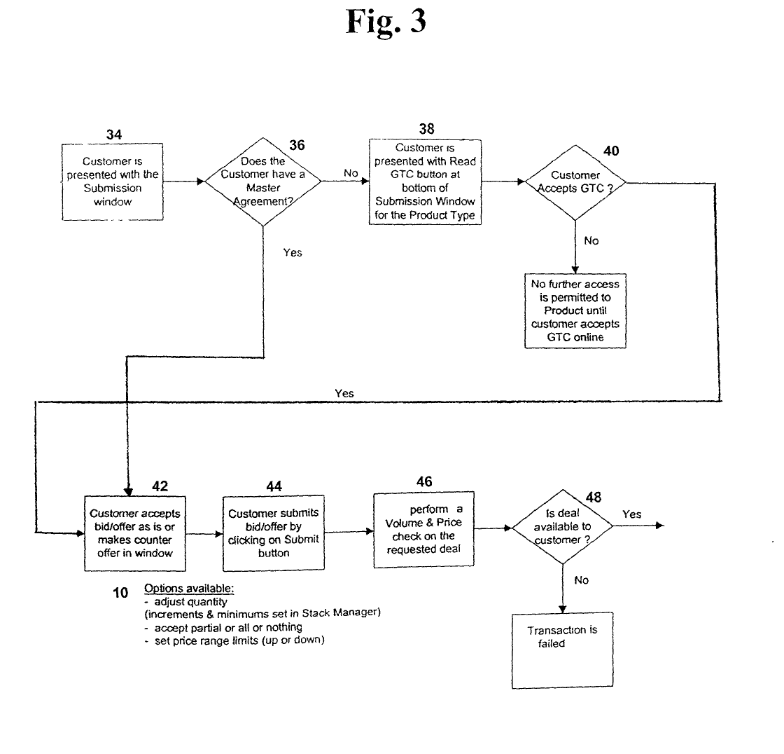

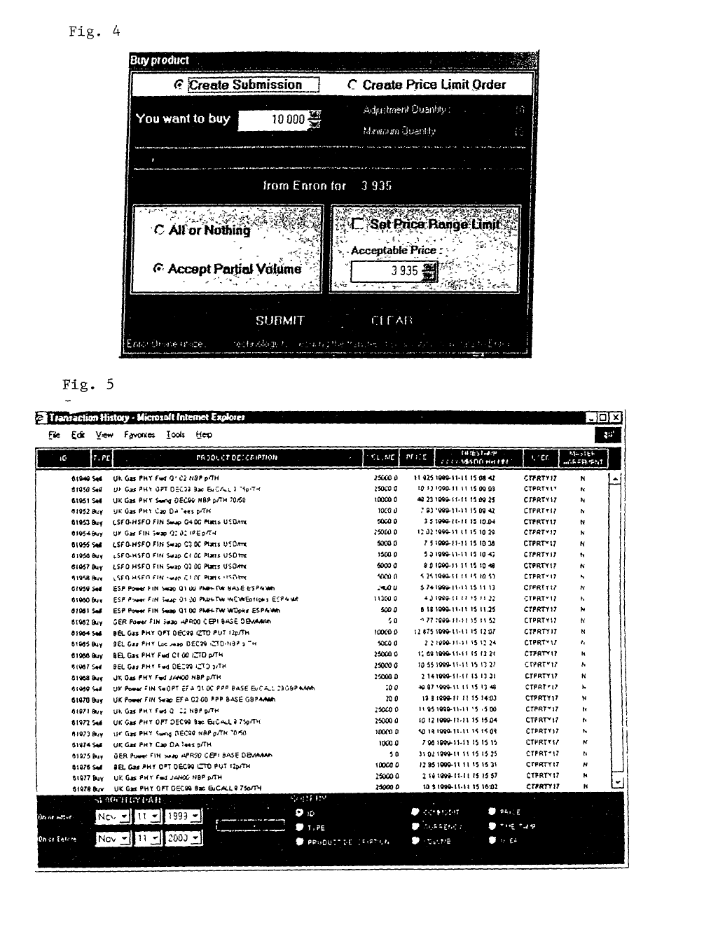

With reference to FIG. 3 and continuing to describe process flow 10, once a Counterparty has determined that it is prepared to submit an offer to enter into a transaction for a product at the bid or offer price then displayed on the website for that product, the Counterparty simply “clicks” once on the bid or offer price displayed on the quotes page for the product in which they want to transact. A submission window 34 displaying the type of transaction (a purchase or a sale), price and volume data that the Counterparty “clicked” on in the quotes page appears, with options that a Counterparty may use to adjust the volume and price range and establish price range limits. FIG. 4 provides an example of a submission window.

If the Counterparty does not want to purchase or sell the entire volume posted for the indicated bid or offer price, the submission window allows the Counterparty to reduce (but not increase) the volume that the Counterparty wishes to buy or sell by adjusting the volume in the transaction submission window; the current embodiment establishes increments by which the volumes may be reduced. The Counterparty can select the volume of a product that he wishes to buy or sell by using direction arrows or by typing in the quantity cell of the submission window. The quantity must be less than or equal to a maximum quantity that the Party is willing to purchase or sell at the displayed bid or offer price (which is the volume accompanying the bid or offer price displayed to the Counterparty on the website) and greater than or equal to the minimum quantity specified in the submission window.

A Party may have a limited volume of product available for sale or purchase at a particular price, which volume will fluctuate as transactions are completed. The Counterparty may also elect to submit an “all or nothing” offer, in which the Counterparty will not enter into a transaction unless it can purchase the entire volume submitted at the specified price; the alternative option (which is automatically selected by default) is the “Accept Partial Volume” option, in which the Counterparty will purchase or sell whatever volume is available at the specified price. Because of “web latency,” or the delay associated with transmitting data over the internet, the entire volume displayed with a particular bid or offer price may not be available by the time a Counterparty's offer reaches the Party (for instance, the volume may have been reduced by a transaction completed immediately prior to receipt of the Counterparty's offer, or the entire volume at a particular price may have been purchased, causing additional volumes to become available but at different prices). The Counterparty can establish a “price limit order,” which allows the Counterparty to set a desired price for a purchase or a sale transaction. If the Party's displayed offer/purchase or bid/sale price moves to the Counterparty's desired price, the transaction can be completed.

The Counterparty can also condition his offer to the Party by specifying a range of prices at which his offer may be accepted by the Party. This option is useful in a period of market price volatility; by specifying a range of prices, the Counterparty's offer could still be filled if the submitted terms cease to be available by the time the Counterparty's offer arrives, but become available again during the trading session.

At the point that the Counterparty is ready to submit his offer described in the submission window, the particular product, price, and volume associated with the offer have been established. However, there may be a need for the parties to establish other particular terms and conditions of the potential transaction, such as measurement, transportation and delivery of product, product quality standards, and payment terms. Most parties typically have a set of non-negotiable, pre-established terms and conditions, or a “form agreement”, upon which they would be willing to enter into a transaction with any other party; however, parties that routinely enter into transactions with each other in particular products may have specifically negotiated contracts to govern all transactions between them in those products. All of these agreements are similar in that each set forth terms and provisions governing transactions in a product (i.e., transfer of title, termination rights, provisions for security, operational conventions such as transportation and delivery), payment methods and payment periods, taxation, force majeure, and penalties for non-performance; however, form agreements are often more general in nature and accepted by the parties “as is,” while negotiated agreements are typically more detailed and precise and reflect a unique business relationship between the parties. The system permits transactions to be completed under both the more general “form agreements,” which are referred to in the current embodiment as “general terms and conditions” or “GTCs”, or agreements that are specifically negotiated by the parties, which are referred to in the current embodiment as “master agreements.”

In the current embodiment, the ETA states that all transactions in a particular product will be governed by either (i) an already existing master agreement between the Party and the Counterparty, or (ii) the general terms and conditions (“GTCs”) that have been established by the Party to apply to transactions in that particular product, which are available for viewing on the website by the Counterparty. In the current embodiment, when a Counterparty that is not a party to a master agreement with the Party for a particular product offers to enter into a transaction in that product for the first time, the relevant general terms and conditions (“GTCs”) for that product will be displayed online to the Counterparty, and the Counterparty must accept, by “clicking” on a designated space on the GTCs, the terms of the GTCs in order to proceed with the transaction. A Counterparty need only accept the GTCs for a particular product once; the GTCs are not required to be displayed (although the Counterparty may always view them at any time) or agreed to for subsequent transactions in a product where the GTCs had been agreed to for the initial transaction in that product. Counterparties that have valid master agreements for a particular product type will enter into transactions for those products pursuant to those master agreements instead of GTCs and are therefore not required to accept GTCs online to trade the relevant product types (which are defined below). In the current embodiment, at that point that a Counterparty is prepared to submit an offer, the system “attaches” the applicable contractual terms and provisions to the transaction. The customer is informed if a transaction is done under an existing master agreement or under GTCs through a transaction summary screen including the key terms of the transaction that appears when a transaction is completed.

In step 36 of FIG. 3, if the Counterparty does not have a master agreement in place with the Party and has not yet accepted the general terms & conditions for the particular product, prior to submitting an offer to enter into a transaction to the Party the Counterparty must first accept the GTCs for the product by clicking on a “Read GTC” button on the bottom of the submission window (step 38). If the Counterparty does have a master agreement in place with the trader, or has previously accepted the GTCs for the product (step 40), then the customer may proceed with submitting its offer to enter into a transaction to the Party. At this point in the transaction process, the Counterparty has identified a product, a bid or offer price, and a volume that he wishes to purchase or sell, and the system has “attached” the terms and conditions (either the Counterparty's master agreement with the Party or the GTCs) that will govern any transaction. The Counterparty is now prepared to submit an offer to the Party.

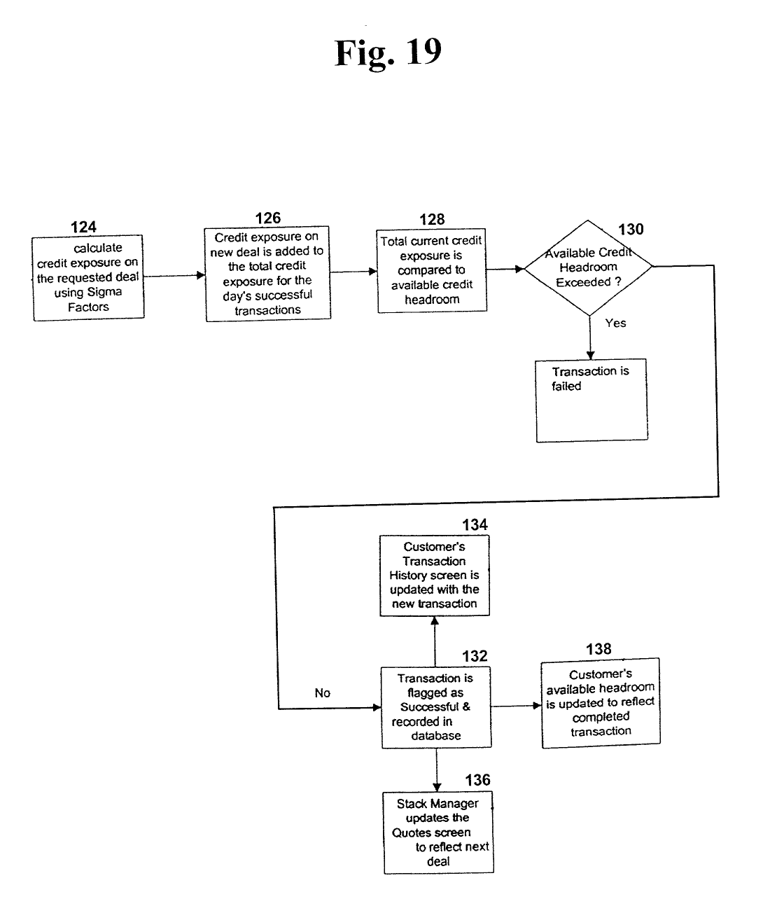

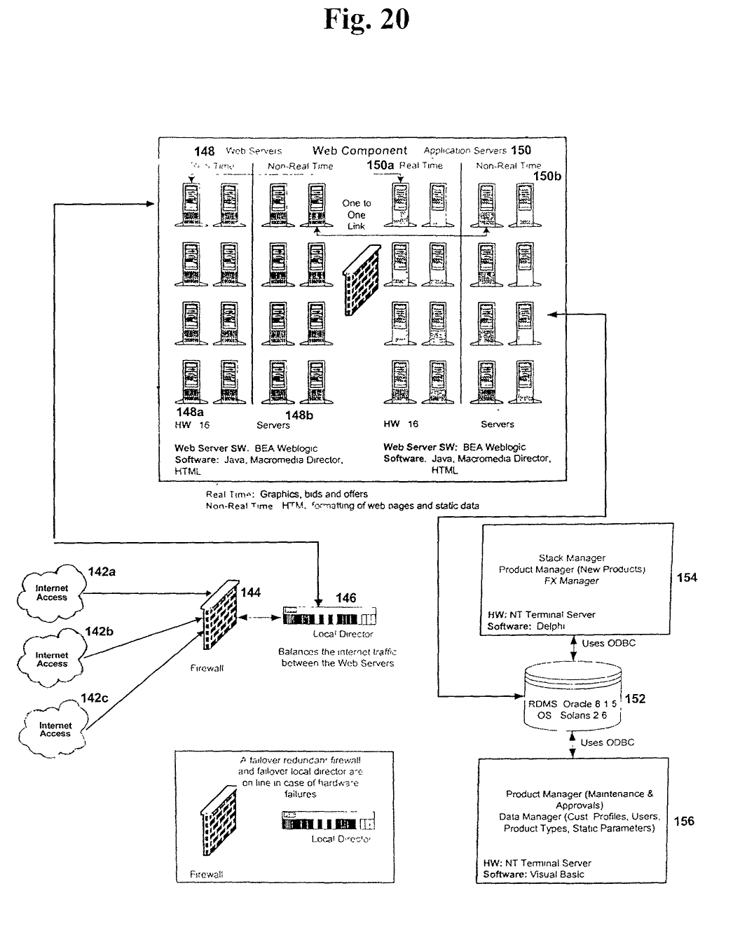

When the Counterparty clicks on the “Submit” button (see step 44 in FIG. 3 and a sample screen in FIG. 4), the Counterparty's offer is transmitted over the internet to the Party. In steps 44 through 48, the system automatically performs a volume and price check; that is, it compares the bid or offer price and the volume contained in the Counterparty's offer to the bid or offer price and volume that is currently available in the “stack” that is maintained by the stack manger described below. If the volume and the bid price or offer price are available, the Counterparty's offer is automatically accepted, subject to additional checks described below. If either the volume or the bid or offer price are not available, the Counterparty's offer is deemed to be rejected. The system also provides for a “credit check,” discussed below and illustrated in FIG. 19, that permits a Party to determine if it is willing to extend credit to the Counterparty for purposes of completing the transaction at the same time that the system is performing a price and volume check; if the system determines that the Counterparty has insufficient credit with the Party to complete the transaction, the Counterparty's offer is rejected.

With reference to FIG. 5, the Counterparty preferably receives a confirmation that a transaction has been completed with the Party, although from a legal perspective the transaction may be deemed to be complete upon acceptance on the website of the Counterparty's offer by the Party. This prevents a Counterparty from denying a transaction on the basis that it did not receive a confirmation, which would be problematic with an automated trading system since the system has completed other transactions on the assumption that the transaction in question was in fact completed. Transactions that are completed may be recorded and displayed to a Counterparty in a separate area, such as the Counterparty's “transaction history.” FIG. 5 shows an example display of a history of the transactions that a Counterparty has entered into, including the product type, volume and price of each transaction. Counterparty would also preferably receive a message that the Counterparty's offer has been rejected and that a transaction has not been completed.

In the current embodiment, the Counterparty submits an offer to enter into a transaction with the Party, even though the Party has displayed on the website products, volumes and prices. Under general contract law, the formation of a contract requires, among other things, an offer and an acceptance. Once an offer has been made, it can be accepted by the recipient of the offer before the offer is either withdrawn by the offeror or expires according to its terms. In the current embodiment, the ETA establishes that, by “clicking” on the submission button in the Submission window, the Counterparty is making an offer to buy or sell a product to or from the Party on terms and conditions set forth in the submission window, which offer the Party may accept or reject. While it may seem counterintuitive that the Party determines and displays prices and volumes for products but the Counterparty makes the “offer” to enter into a transaction for those volumes at those prices, this business model gives the Party—not the Counterparty—ultimate control over whether or not a transaction is completed. In this manner, the Party may determine, with respect to any particular offer submitted by a Counterparty (i) whether the Party continues to be willing to enter into a transaction at the price that the Counterparty has “clicked” upon and is thus offering; (ii) whether the Party continues to be willing to purchase or sell the volume that the Counterparty is willing to sell or purchase, and (iii) whether the Party is willing to extend credit to the Counterparty for that particular transaction. To demonstrate, in an active market many potential Counterparties may be attempting to purchase or sell a particular volume of Product at a particular price proposed by a Party at the same time, but the Party has limited the volume of the product that the Party is willing to purchase or sell at that price. By requiring the Counterparty to make an offer to enter into a transaction, the Party is able confirm product availability, price, and the Counterparty's credit headroom before accepting the Counterparty's offer and creating a contract with the Counterparty; more importantly, if any of the product, price or credit are not available for any reason (perhaps because immediately preceding transactions have exhausted the available volume at a given price), the Party may reject the Counterparty's offer and therefore has no obligation. If the business model provided that the Party was offering to enter into a transaction at the price and volume displayed, the Party could become obligated under numerous contracts in excess of the available volumes because the Party may not be able to withdraw its offer quickly enough to avoid acceptance of its offer by multiple Counterparties.

After a transaction has been entered into via the website, delivery, acceptance, and payment for the product occurs outside the present system and within existing means for exchanging possession of products. For example, natural gas may be transferred from one owner to another via a pipeline, or electricity may be transferred via an electrical grid. Accounting, invoicing and payment functions occur as well, which may be integrated with the present system.

In summary, from the Counterparty's perspective, the system makes transacting with the Party very simple for the Counterparty, with as few as two clicks required to transact. It also makes transacting with the Party a virtually automatic process, with streamlined documentation and no need for negotiation.

The Product Manager Software. The foregoing describes those elements of the invention that a Counterparty may access or see in the course of entering into transactions with the Party through the website. The system also provides the Party with several tools that enhance the Party's ability to quickly and efficiently transact with Counterparties via the website. The Party uses a “Product Manager” software to create, describe, and manage products available for purchase and sale on the website; the Party uses the “Stack Manager” software to establish and display prices and volumes for products that are available for purchase or sale on the website, and to manage the Party's transactions in those products on the website.

For the Product Manager and Stack Manager applications, there are two types of users: a manager and a trader. The manager has the ability to delegate and control permission to operate these applications to other users, including viewing stacks for certain product types and publishing stacks for certain product types, and suspending product types as appropriate. The trader has access rights to manage products on the Stack Manager application as determined by the manager.

The Party uses the Product Manager to create accurate and detailed descriptions of the products that are available for purchase or sale through the website. In order to ensure a binding contract and minimize commercial disputes, the parties to a transaction should, at the inception of the transaction, agree to all of the key terms of the transaction; in a purchase and sale of a product, these terms include the specifications and attributes of the product that is being purchased or sold. Product Manager software is used for creating descriptions of products that are sufficiently detailed to clearly identify the product that is the subject of a transaction entered into via the website, quickly make new products available through the website, activate or deactivate existing products, and make changes to products.

In the current embodiment, the Product Manager creates a product description by combining the product's various attributes. Depending upon the product, there can be a number of different attributes describing that product; by way of example, attributes of a natural gas product may include some or all of the following: the commodity (natural gas); product type (e.g., physical forward firm); region (e.g., U.S.); delivery location (e.g., the Henry Hub, a well-known U.S. delivery location for natural gas); index (e.g., Gas Daily, a published natural gas price index); term (the period of time over which delivery is to occur, e.g., February 2000); and currency (the currency in which payment for the product is to be made, e.g., U.S. dollars). A Party uses product manager software to “build” a product description by combining the product attributes that the Party selects. This ensures consistency in the form of descriptions for all products that are available for purchase and sale on the website, regardless of the individual trader that created the product.

In the current embodiment, each product has two descriptions—a “product short description” that is used to identify and describe the product on the quotes page and the transaction summary page, and a “product long description” that can be accessed and viewed from the quotes page that identifies and describes the product in greater detail. A product description may consist of four parts: (1) product type; (2) product additional information; (3) reference period; and (4) currency and unit of measure.

The “product type” is comprised of country, commodity, deal category, deal type, and firmness attributes; examples of a product type are Canadian Firm Physical Gas Forward, or U.S. Gas Physical Forward firm. An individual product within this product type would include the reference period (for a gas product, the delivery period, such as April 2000), and currency and unit of measure (for a US gas product, U.S. dollars per MMBTU). Product additional information is additional information, specifications or attributes, varying by product, that are considered necessary to adequately describe the product for purposes of ensuring an agreement among the parties as to the specifications of a product and supporting a binding contract for the purchase or sale of the product. Certain of the attributes found in the product additional information have an associated abbreviation that is used in the short description and an associated sentence (or group of sentences) that is added to the long description.

Accordingly, the short description for a natural gas product that may appear on the quotes page may include the product type, a location, reference period, and currency, such as:

### US Gas Basis EP Permian Apr-Oct02 USD/MM

The respective long description for this product may be:

A US gas financial Swap Transaction with Party, under which either (A) for the case in which Counterparty submits an offer to buy from Party, Counterparty shall pay the Fixed Price and shall receive the Floating Price, each in respect of the Notional Quantity per Determination Period; or (B) for the case in which Counterparty submits an offer to sell to Party, Counterparty shall receive the Fixed Price and shall pay the Floating Price, each in respect of the Notional Quantity per Determination Period. Each calendar month during the term of the Transaction will be a Determination Period. The Notional Quantity per Determination Period is the volume submitted multiplied by the number of days in the relevant Determination Period. The Payment Date(s) will be 5 business days after both the Fixed Price and the Floating Price are determinable. The Floating Price shall be the average of the Index for each day in the relevant Determination Period. The term of the Transaction shall correspond to the date(s) set forth in the Product description on the Website. The Fixed Price shall be the settlement price for the last scheduled Trading Day of the NYMEX Henry Hub Natural Gas Futures Contract, modified by the price submitted by the Counterparty on the Website, for the applicable Determination Period. The Index shall be the first price published during the applicable Determination Period by the Inside FERC's Gas Market Report in the section “Prices of Spot Gas Delivered to Pipelines” under the heading El Paso Natural Gas Co., Permian Basin. The price is quoted in US Dollars per unit of volume, which will be the Contractual Currency. The unit of measure against which the price is quoted shall be millions of British thermal units and the quantity shown shall be in millions of BTUs per day.

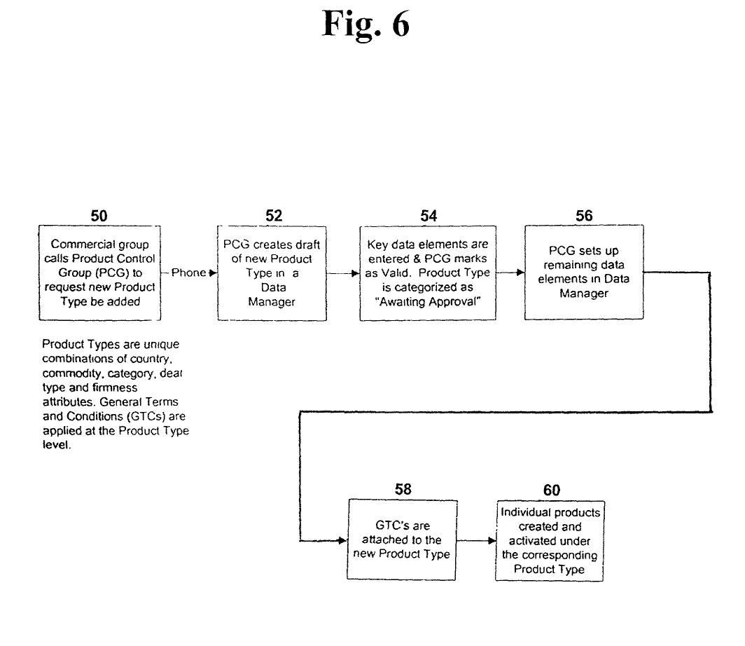

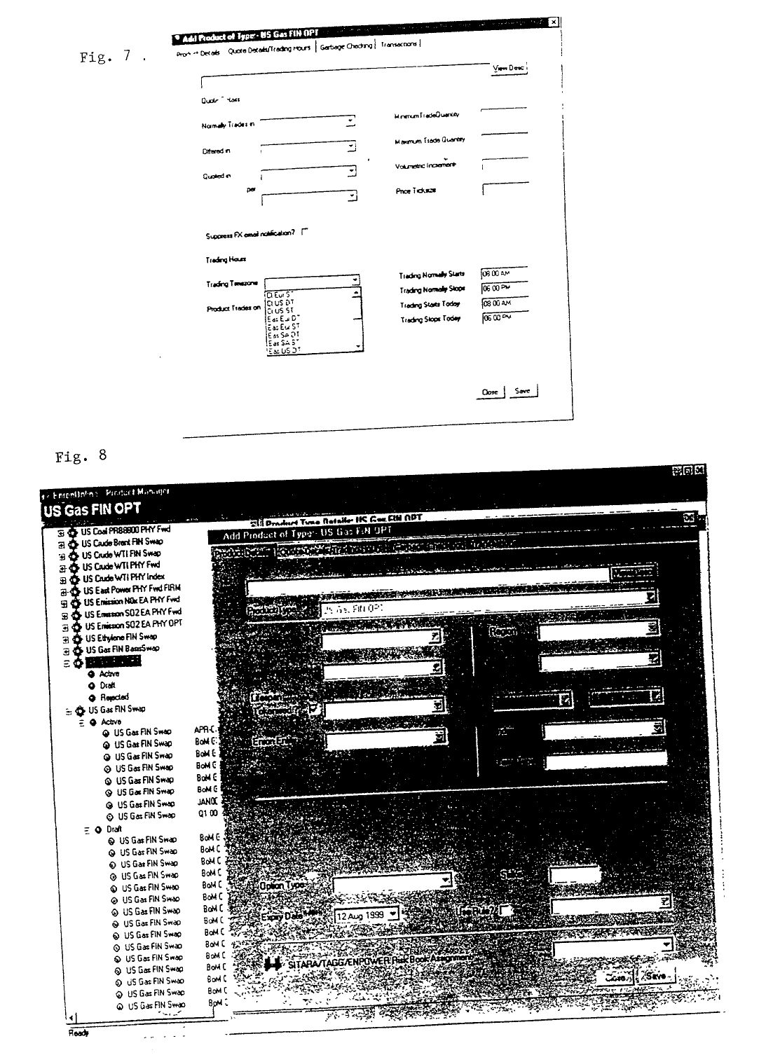

Turning to FIG. 6, products are created by the Party by first designating the “product type”, as indicated in step 50. In steps 52 through 58, a product type is added to the Product Manager, product short and long descriptions are prepared for a product, and general terms and conditions (GTCs) are prepared and attached to the product type. In Step 60, individual products can then be established for the product type. FIGS. 7 and 8 illustrate screens that can be used to add new products to a specified product type by selecting product attributes and providing product details, quote details, trading hours, and other information. FIG. 7 illustrates a screen used to create a product that is a financial option with a U.S. natural gas basis.

Product Manager software also enables a party to avoid mistakes while using the stack manager to establish prices or volumes of products that are available for purchase or sale through the website. As discussed in more detail below, a Party may use the stack manager to manually enter into the system the Party's bid and offer prices and related volumes for products. Typographical errors can result from the process of keying in this data, and because the invention uses an automated system for completing transactions as discussed above, errors in price or volume data may not be detected until after a transaction has been completed by the system. The product manager permits a Party to install “checks,” also referred to as “garbage checks,” on the information that a Party enters into the system to assist the trader in identifying erroneous data before it is displayed to and possibly transacted upon by potential Counterparties. Errors commonly occur in entering a price; the product manager may set price checks as a percentage price check, in which the system will identify a price that is outside a specified percentage of the price at which the immediately preceding transaction was completed. Alternatively, the product manager may set price checks as an absolute price check, in which the system will identify a price that is outside a specified deviation from the price at which the immediately preceding transaction was completed. An initial garbage check price must be specified so that the system has a baseline to measure against when the first real price is entered into the system. A Party may specify that the system will provide a warning before permitting the Party to proceed with entering the price, or may specify that the system will simply fail to add a new price.

The Stack Manager Software. Once the Party has established products using the product manager software, a trader can use the stack manager software to (i) establish the prices and volumes for those products that will be displayed on the website to potential Counterparties, (ii) display the Party's best bid and offer prices and associated volumes to potential Counterparties, and (iii) manage the Party's transactions on the website for those products.

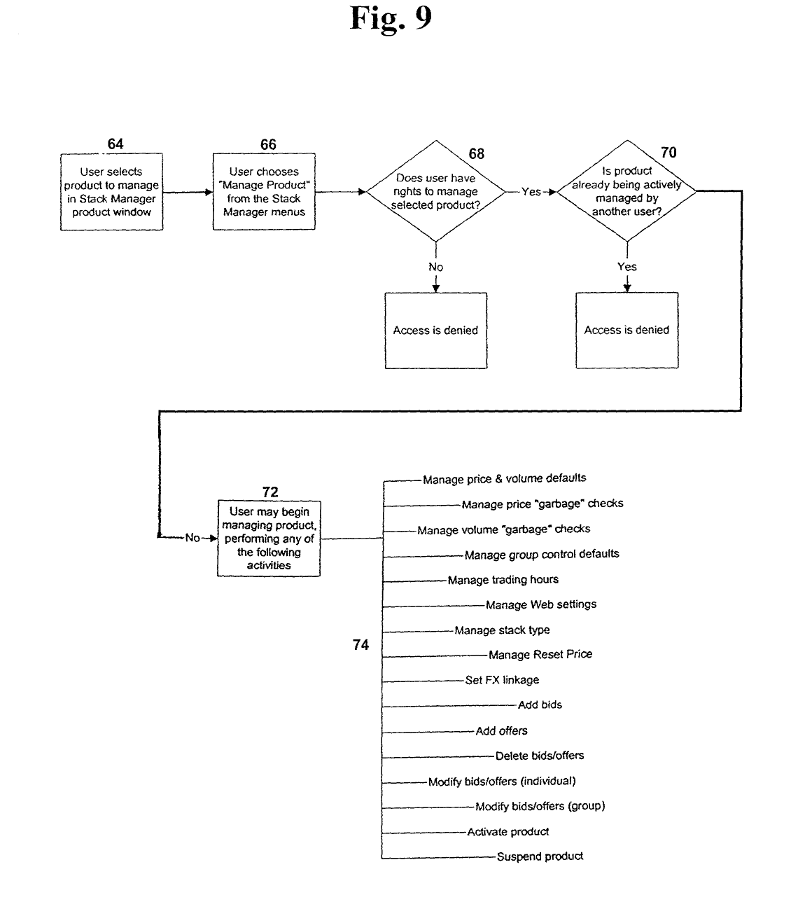

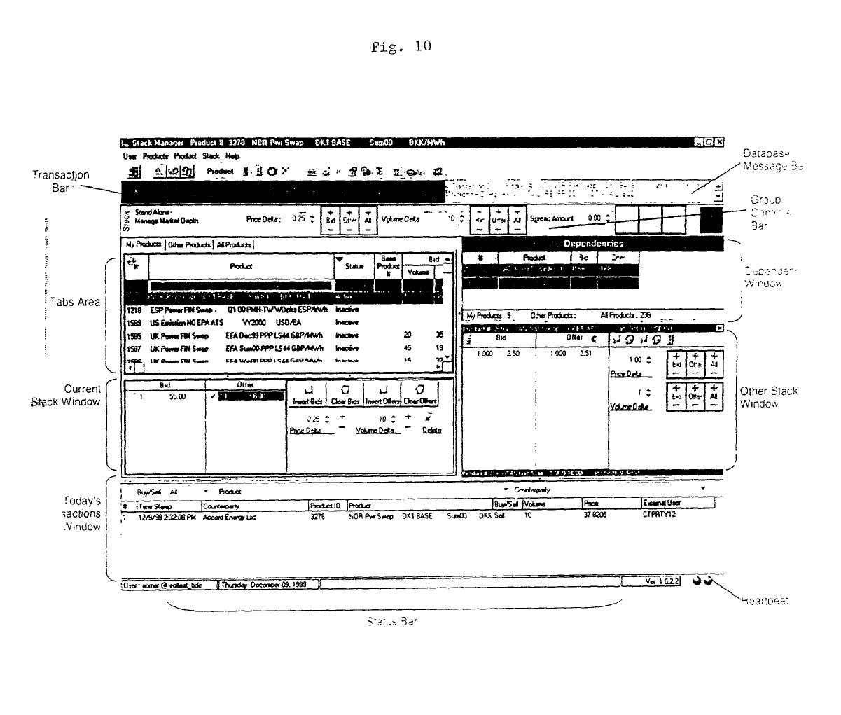

The “stack manager” software is the primary application through which traders manage the bid and offer prices and volumes for products that are purchased or sold through the website. “Stacks” refer to the individual sets of a bid price, offer price, and associated volume that are established by the Party for a product and that the Party intends to display to potential Counterparties to invite offers. Each product has one bid stack and one offer stack maintained for it (although those stacks may be linked to stacks of different products, as discussed below). The stack manager software is linked directly to a database that contains all of the price and volume data that populates the stacks. Information is entered into the database through the stack manager application. FIG. 9 illustrates how a Party uses the stack manager software to manage various aspects of buying or selling products over the computer network, including specifying the prices and volumes that will go into the stacks. A trader selects the particular product that he or she wishes to manage through the stack manager software (step 64) by choosing a “manage product” option from the stack manager menu (step 66). If the trader has been allocated rights by his or her master user to manage that particular product (step 68), and if no other trader is currently actively managing that particular product (step 70), then the trader may begin managing the product using the stack manager software (step 72).

As indicated in step 74, a trader using the Stack Manager software can add, delete or modify bid and offer price and volume entries, link stacks, manage price resets, define stack strategies (discussed in more detail below), take responsibility for management of certain products, view completed transactions, set market times, set general and specific price and volume controls on stack entries, view activity by Customers that are logged in, and view product positions during the session.

However, the primary use of the Stack Manager software is to set prices. For a particular product, the trader establishes a list, or a “stack”, of data entries, where each entry in the list, or stack, is a combination of the Party's bid price, offer price and a related volume (amount) or quantity of the product for which the bid or offer price is available. The Stack Manager software maintains the stack elements with the “best” bid and offer prices (that is, the prices most favorable to potential Counterparties, or in other words, the highest price that the Party is willing to pay for the product or the lowest price at which the Party is willing to sell the product) at the “top of the stack.” A “spread,” or the difference between the bid price and the offer price, is typically maintained between the bid and offer prices, with the bid price typically being lower than the offer price (so that the Party can make a profit if the Party buys and immediately sells the product). While a Party may maintain stacks of bid/offer prices and related volumes for a particular product, Counterparties do not have access to the stack manager, and only the “best” bid and offer price and associated volume or quantity is transmitted and displayed to potential Counterparties at any particular time. The potential Counterparties cannot view the bid/offer prices that are further down in the “stack;” only the Party that is managing the Product through the Stack Manager software can view the other bid and offer prices in the stack.

The stack manager continually updates the bid/offer/volume combinations as transactions are completed. When a customer selects the displayed bid or offer price for a product and completes a transaction in that product, the volume for that transaction is deducted from the volume available for that bid or offer price (as applicable), and the remaining volumes for that bid or offered price are then displayed to other potential Counterparties. If the prior transaction completely depletes the volume for that bid or offer price, the next bid or offer in the stack and associated volume will immediately appear to replace the bid or offer that was transacted upon. For example, a series of prices have been entered in the stack, with the best bid price being $2.10/unit for 10,000 units. Another bid entry in the stack may be at the same price of $2.10/unit, but with an associated volume of 8,000 units. This will be the second item in the order of the bid side of the stack. When the top stack item of $2.10 and 10,000 units has been transacted and depleted, then the $2.10/unit item below this with 8,000 units will be displayed as the bid item. The customer will not see the bid price move, but will see the bid volume change. Alternatively, assume a series of prices have been entered in the stack, with the best bid price being $2.10/unit for 10,000 units, and the “next best” price in the stack of $2.05/unit, but with an associated volume of 8,000 units. This will be the second item in the order of the bid side of the stack. When the top stack item of $2.10 and 10,000 units has been transacted and depleted, then the $2.05/unit item below this with 8,000 units will be displayed as the bid item. The customer will see the bid price and the bid volume change. Preferably, a “push” technology is used to update the bids and offers displayed by the Party in the Quotes area, such that updated bids, offers and other information is automatically displayed on the Counterparty's screen, and the Counterparty does not need to “pull” or “refresh” the data on the Counterparty's screen in order to retrieve the most current bids and offers.

A Party may use a variety of methods to “build” astack, depending on the Party's objectives in the marketplace. It is possible, for instance, to create a stack in which all of the prices and quantities are the same. Therefore, from the perspective of the Counterparty that is viewing the prices for a product on the website, the “market” for that product will not move regardless of whether or not Counterparties are buying or selling the maximum volume that is visible on their screen at any one time. Alternatively, a Party might build the stack with a series of identical volume entries, but with prices moving up or down in defined increments. With this kind of stack, as Counterparties complete transactions in that product, the “market” for a product will appear to move up or down. One may also amend each individual entry on either or both the bid and offer sides of the stack to a desired value. The bids and offers are arranged in price order with the “best” bids and offers at the top of the stack. More complex methods for assembling “stacks” are discussed below.

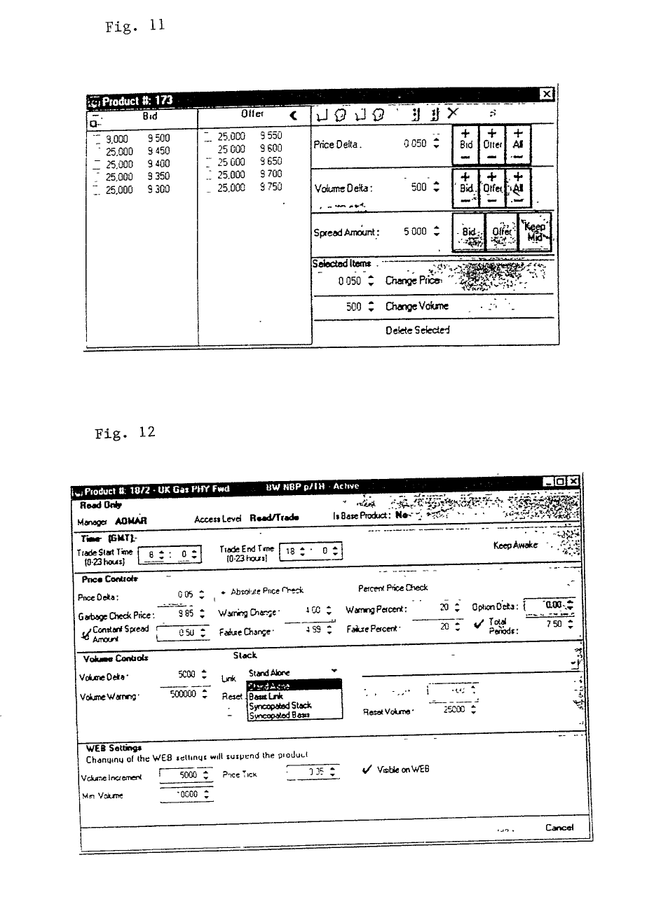

FIGS. 10 and 11 illustrate sample screens through which a Party can interact with the stack manager software. While any number of different configurations of the screens are possible, in the current embodiment an application window is provided for the stack manager that includes a product area with three tabs that provide views of products inside the stack manager labeled “my products,” “other products,” and “all products.” A window with controls for the currently selected stack is located below the tabs window.

A “today's transactions” section shows any transactions that have been completed for any of the managed products during the current day. One can filter the list of transactions by type of transaction (buy or sell), the particular product, and by the Counterparty with whom the transaction was completed. When an individual product is selected, the status bar at the bottom of the application window shows the number of buys and sells that have occurred for that product that day.

A “dependencies window” shows any links that may have been established between stacks for the displayed products and other stacks (“linking” stacks is discussed in more detail below). If one sets up product stacks that are linked to another product stack, the updated bid and offer prices relative to the base product are shown.

A “speedbar” shows icons for “shortcuts” that can be used within the stack manager to perform the most common functions. A transaction bar displays the current date. When active stacks are managed, the bar will display the details of the last transaction that occurred, including the product description, the price at which the transaction was completed, and the time of the transaction.

A database message bar shows messages from the database that are relevant to the current session. Any error messages can be shown here, along with notifications regarding customers who have tried but failed to transact due to market movement or application of credit limits. An error message for a failed stack manager application action is also displayed here.

The product status column in the product tabs area displays the status of the product at the current point in time, which can be either active, inactive or suspended. If active, the product is currently being managed and any bid and offer prices inserted into the stack by the trader will be published on the website. Active products are available for viewing by all Counterparties who have access to that product. If inactive, the product is not being monitored by the database and prices and volumes are not published on the website. If suspended, the product is normally available for viewing by customers but is temporarily removed from customer's view. The database still monitors these products but does not display this information on the website.

From the trader's perspective there is no difference between a suspended or inactive product; in both cases customers will not see prices and will not be able to transact in these products. A product can be automatically suspended upon certain occurrences specified by the Party, such as when a constant-bid offer spread has been specified and either the bid or offer side of the stack is empty. Products are also suspended when outside market hours.

In particularly active or volatile markets, current price and volume information is preferably immediately transmitted from the database and displayed to potential Counterparties, and products are preferably actively managed. Because the loss of the stack manager's communication with the database could result in failed or erroneous transactions, a “heartbeat” displayed on the stack manager's screen assures that the desktop is communicating with the database. For example, every 30 seconds, the connection to the database is automatically polled; if there is no response from the database at any time that it is polled, then the heartbeat turns red to indicate that a connection is not detected, at which time the active products which were being managed will automatically be inactivated. Additionally, the database is periodically messaging the stack manager application to verify that the messaging infrastructure is healthy. This eliminates the possibility that Counterparties may be attempting to transact on data that is no longer current.

An “all-products” tab displays the details of all the products that a trader is authorized to manage. This displays the product ID number, product short description, the current manager of the product, the status of the product and the best bid and offer prices and volumes. The best bid and offer prices and volumes displayed on the all-products tab are not automatically updated due to the enormous amount of data that would need to be refreshed on all users' tabs; the prices are refreshed upon login or by selecting a “refresh” icon from the speedbar. One may select to manage any inactive product from the list presented on the all-products tab.

A “my-products” tab shows all products that are currently managed by the user. When one clicks once on any product within either the my-products or other-products tab, the stack for that product will automatically be shown in the current stack section below the product tabs window. Bids or offers can be inserted into the stack by clicking on an “insert bids” or “insert offers” icon in the current stack window.

Each trader may have a set of products that he or she manages. It is also possible for multiple traders to view the stack for the same product, but only one trader has manager status and can manipulate the stack at any one time. However, the stack manager may be configured so that a trader can “log on” to more than one computer using the same username and password. This allows the trader to have the stack manager application open on two computers simultaneously in case one of the computers fails. Multiple sessions also allow more than one user to manage the same stack. For instance, there may be some products in which transaction activity is so heavy that two traders on the same desk need to jointly manage the product. When Trader 1 is the current manager, Trader 2 can open up another session of the stack manager using Trader 1's username and password to be able to view and manage those common products. Both users will then be able to perform the full range of functions afforded by the stack manager to the stack. When one trader updates a price or volume, the other trader will also see the change.

The stack manager allows for defining relationships between products. For example, it is possible to set the pricing of one product so that it moves in proportion to price movements of another product. It is also possible to set up the stacks so that if volumes are taken from one product, then volumes cease to be available from another product. Several tools allow for construction of stacks to achieve more complex strategies and relationships among different products.

FIGS. 12-14 illustrate the manner in which the stack manager allows one to build complex trading strategies for each product stack. There are twelve main types of stacks that can be created by selecting from combinations of up to four stack linkage types or up to three types of reset value for individual entries within the stack. One can choose any combination of stack link and stack reset to develop the most appropriate stack strategy for a product. Stack selection is made form the “product properties” window illustrated in FIG. 12.

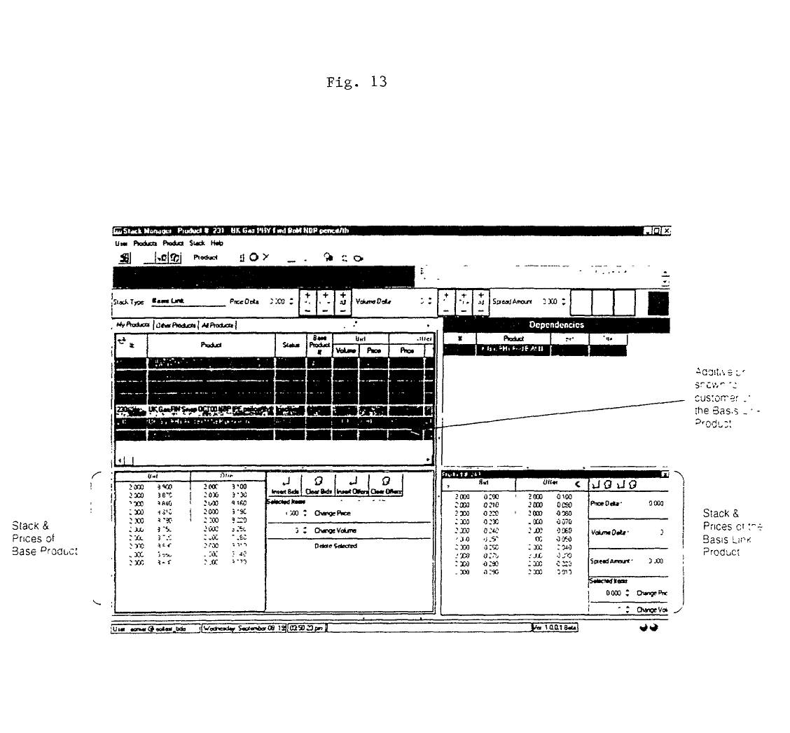

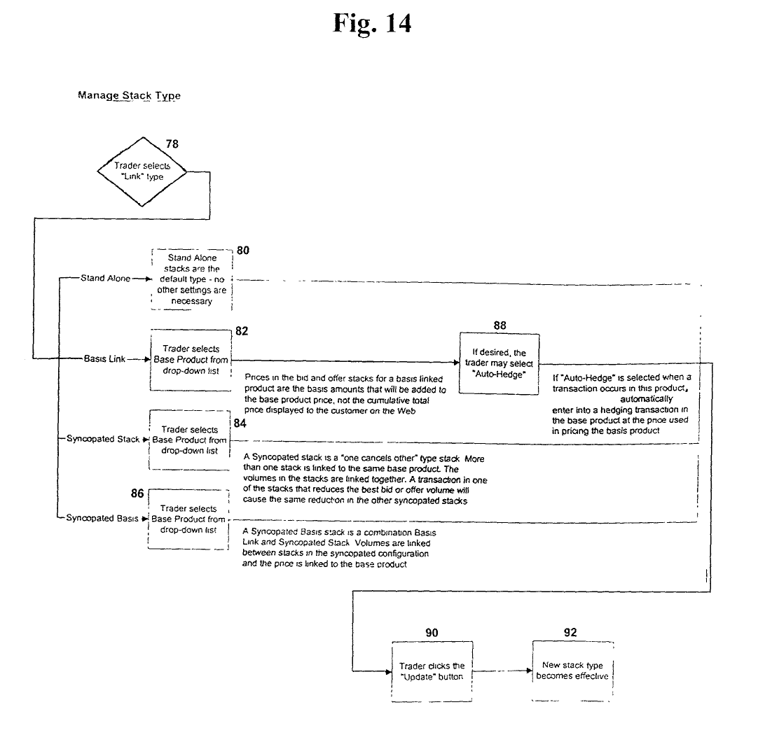

In step 78 of FIG. 14, a trader selects a stack type. There are four different types of stacks: (i) a stand-alone stack 80; (ii) a basis link stack 82; (iii) a syncopated stack 84; and (iv) a syncopated basis stack 86. FIGS. 12 and 13 illustrate screens that a trader can use to select the stack type and links. After a stack is selected, the trader clicks an update button 90, and the new stack type becomes effective (step 92).

When products are first created, their corresponding stacks are created as stand-alone stacks by default. In these stacks, one trader manages and controls the prices and volumes in the stack independently of the prices or volumes in any other stack and without any automated process or mechanism. However, it may be useful to establish prices for a product that track the prices for some other product. For instance, there are published price indices for numerous natural gas products to which a counterparty may turn for pricing information for natural gas delivered to a particular delivery point at a particular time. For instance, a customer can consult an index to determine the forward price for natural gas delivered to the Henry Hub in June 2001. A party may want to determine prices for his product (which may have a different delivery point or term) based upon this index price. Basis-link stack 82 is one where the prices in the stack for products being managed are added to the price of the product that is specified as the “base product.”

In a basis link stack, a trader manages only the basis price, and the prices within the basis stack are basis amounts only. However, the total price of the product, i.e. the price of the base product plus the basis price, is displayed on the website to the customer. The basis amounts in bid and offer stack may be positive or negative. As an example, a first trader manages a US natural gas product delivered to the Transco Zone 6 location. Instead of simply offering fixed prices for this product, the trader can manage it as a basis linked stack such that the price for his product fluctuates according to the prices for a base product, say, US Gas Nymex, which is managed by a second trader. The first trader then builds a basis stack that includes the basis amounts that the trader wants to have added to or deducted from the price of the base product to determine the price of the first trader's product. Assuming that the best bid and offer for US Gas Nymex is currently $2.10 and $2.20 per MMBTU (which prices were established by the second trader), and the best bid and offer basis prices in the Transco Zone 6 stack are $0.20 and $0.30 per MMBTU (which prices were established by the first trader), the best bid and offer price that will be displayed to customers for the Transco product is $2.30 and $2.50 per MMBTU.

Effectively, the first trader establishes bid and offer prices for his natural gas product based on the bids and offer prices of US Gas Nymex, which is managed by the second trader. The US Gas at Transco Zone 6 stack has been created as a basis-linked stack, with US Gas Nymex as the base product. Since the first trader does not manage the base product (US Gas Nymex) as a product within his “My products” or “Other products” tab, he will not see any changes in bid or offer prices of that product from the product area, although that product will appear as a dependent base product in the dependency window.

Because the first trader cannot see the market for the base product, the prices of which determine the prices for his product, the system provides the first trader with a tool to reduce his exposure to price movements in the base product. A tool called an auto-hedge (step 88) is built into the stack manger for reducing exposure to price movements in a base product (FIG. 14). Auto-hedge 88 will automatically enter into a hedging transaction in the base product as soon as a transaction is completed in the basis link product at the price that was used in pricing the basis product in the transaction. The maximum volume for an auto-hedge transaction should not exceed the volume of the parent product.

A trader may also wish to offer to purchase or sell a product in several different markets but limit the aggregate volumes that can be purchased or sold in all of those markets. Syncopated stack 84 is an OCO, or “One Cancels Other,” type stack. In an OCO type stack, the volumes in the stacks are linked to one another. When a transaction reduces the available volume in one stack, that volume will also be deducted from the volumes available on the other syncopated stacks. While there can be more than one product linked together in a syncopated configuration, all of the stacks in a syncopated configuration should be linked to one single parent.

As an example, assume that a trader has 100,000 MMBtu's of natural gas at a source location. He also has available transportation to three distinct delivery locations A, B and C. As the trader only has 100,000 MMBtu's available for sale, he offers for sale the full amount of 100,000 MMBtu's at each of locations A, B and C. Because natural gas for delivery at location A, B and C are three different products in the system, each product is assigned its own “stack.” If 10,000 MMBtu's are sold at location A, the trader will have 90,000 MMBtu's remaining for sale. The syncopated stack configuration will automatically adjust the volumes that are offered for sale at locations B and C. In creating the syncopated configuration, the trader should establish either A, B or C as the parent location. Thus, if he chose A as the parent, he would establish each of B and C with A as the base (parent) product.

Syncopated basis stack 86 is a combination of a basis linked stack and a syncopated stack. Here, volumes in the stack for the product are linked to volumes in the base product (in the manner set forth in the description of the syncopated configuration described above), and the prices for the product are linked to the price of the base (parent) product in the configuration (in the manner set forth in the description of the basis linked stack described above) (FIG. 14). In this case, a trader may have available a specified amount of power at a central hub location called H. He wishes to offer to sell this power at any of the delivery locations D, E or F. Transmission capacity is available to each of these locations, but only enough to accommodate the amount of power that he has available at location H. Because of transmission constraints, the products at locations D, E and F typically trade as basis products with the base product being power for delivery at the hub location H, and the basis prices reflecting, among other things, the costs of transportation to locations D, E and F.

Assuming that the trader does not want to sell more power than he has available at location H, he sets up the three products—power gas for delivery at each of locations D, E and F—as syncopated basis stacks, with the product at the hub location H as the base (parent) product in the configuration. This means the trader only has to manage the basis prices for each of the three products and the price of the product at the hub location. This also ensures that as transactions occur in a given product (meaning a portion of the available power has been sold for delivery to a particular location), these volumes are deducted from the volumes available at each of the other locations.

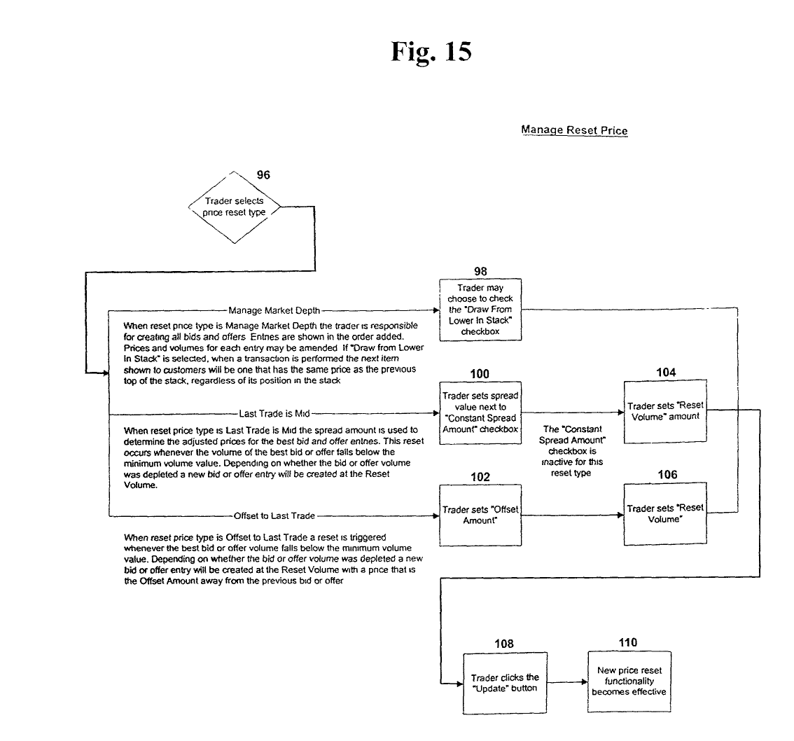

While a trader managing stacks may manually change bid or offer prices or volumes within a stack, a trader may also change bid and offer prices in a stack in an automated fashion by utilizing one of the price reset features illustrated in FIG. 15. This feature allows the trader to manage his product through changes in the market in an automated fashion using the stack manager software so that the trader does not need to continually monitor the market for his product and manually change prices to adapt to those changes in the market. In step 96, a trader selects a type of price reset, which updates bid and offer prices after a transaction is completed. There are three types of price resets that can be selected for each stack: (i) a manage market depth reset 98; (ii) a last trade is mid reset 100; and (iii) an offset to last trade reset 102.

With “manage market depth” reset 98, one can manage the entire “depth” (that is, the number of price and volume entries) of the stack. A trader using this price reset must create all bid and offer entries in the stack, and entries are shown in price order

Alternatively, a trader may select a type of price reset that, immediately upon execution of a transaction in a product, automatically adjusts the next best bid and offer prices and volumes in the stack for display to potential counterparties on the website for the next transaction. When price is reset using “last trade is mid” reset 100, a trader specifies a spread amount and a reset volume in step 104. The spread amount is used to determine the next available bid and offer prices after a transaction has been completed. The prices of next best bid or offer are adjusted to reflect a spread between the bid and offer prices with the last transaction price as the mid-point of this spread. The reset volume is used to replenish volumes available for purchase and sale after the previously available volumes have been purchased or sold. When the volume of the best bid or offer falls below the minimum volume specified for the product, additional volumes are automatically added to the bid or offer column (depending on whether the bid or offer entry is depleted) in the amount specified in the reset volume cell. When selecting last trade is mid reset 100 for the stack, one sets a spread amount that remains constant.

For example, the following entries appear in the bid and offer columns of a product stack.

| Bid Volume | Bid Price | Offer volume | Offer Price |
|---|---|---|---|
| 2,000 | 2.20 | 3,000 | 2.28 |

The trader has established the minimum volume for this product at 600 units, the reset spread at 0.08, and the reset volume at 3,000.

Assume that two consecutive transactions occur at the bid price of 2.20 and a volume of 500 units each time. Assume another transaction then occurs at a volume of 500 units and at the bid price of 2.20. The bid volume is now 500 units and is below the minimum volume. The system automatically creates a new entry of 3,000 units on the bid side of the stack. Since the last transaction occurred at 2.20, this price will become the mid point of the new spread, which is 0.08 wide. The new spread is therefore 2.16 to 2.24, the new bid price becomes 2.16, the new offer price becomes 2.24, and the new bid volume is 3,000 units.

When prices are reset using “offset to last trade” reset 102, one also specifies an offset amount in step 102 and a reset volume in step 106 (FIG. 15). Upon completion of a transaction in which the bid volume or offer volume falls below the reset volume, additional volume equal to the reset volume is entered into the bid or offer column (depending on whether the bid or offer volume has been depleted). The new bid price or offer price is the price at which the immediately preceding transaction was completed, minus the offset value if the bid price is being adjusted and plus the offset amount if the offer price is being adjusted.

For example, the following entries appear in the bid and offer columns of a product stack.

| Bid Volume | Bid Price | Offer Volume | Offer Price |
|---|---|---|---|
| 2,000 | 2.20 | 3,000 | 2.30 |

Assume that the trader has established the minimum volume for the product at 600, the offset amount at 0.10 and the reset volume at 5,000. Assume that two consecutive bid transactions occur at the bid price of 2.20 and a volume of 500 units each time, and that another transaction occurs again at the bid price of 2.20 and a volume of 500 units. The bid volume is now 500 units and is below the minimum volume. The system automatically enters 5,000 units on the bid side of the stack. Since the last transaction occurred at 2.20, this will become the price to which the offset is deducted, creating a new bid price of 2.10. After a trader has selected a price reset type, the trader implements a price reset by clicking on an update button (step 108), and the new set of bid and offer prices becomes effective (step 110).

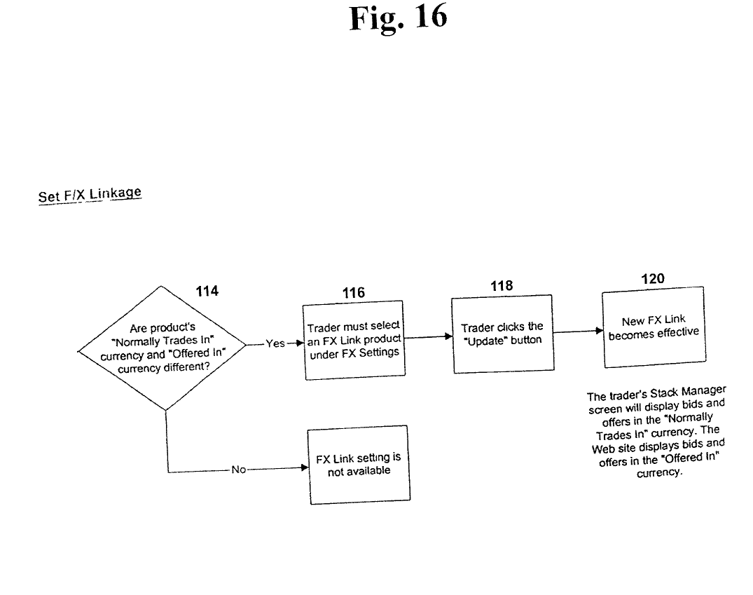

With reference to FIG. 16, a Party may wish to create a product that trades in a currency other than the currency that the product is typically offered in; for example, a party may wish to offer or purchase a U.S. natural gas product in Canadian dollars. In order to create this product in the system, the Product Manager will be required to include two associated currency fields in a currency stack type FX (for foreign exchange). In step 114, the first currency is that associated with the underlying (or valuation) curve for that product, labeled ‘Normally Trades In.’ The second currency is the one in which prices are shown to clients on the web, labeled ‘Offered In.’Products that have different values for these two fields are assumed to have embedded in them risk associated with fluctuations in foreign exchange rates, or what is also referred to as “FX risk.”. Such products are automatically identified as potential FX candidates within the stack manager application.

A trader may link these products to a foreign exchange product to mitigate the foreign exchange risk associated with these products in step 116, selecting an update button 118 so that a new foreign exchange link becomes automatically effective in step 120. The FX exchange product to which the commodity stack is linked appears in the dependencies window. The FX exchange products are also visible from within FX manager, which is a separate application used by an FX trader to manage FX products. The prices entered by the trader through the stack manager are entered in the underlying currency, and the FX exchange product then converts the stack prices to the bid and offer prices in the currency in which the product is to be offered.

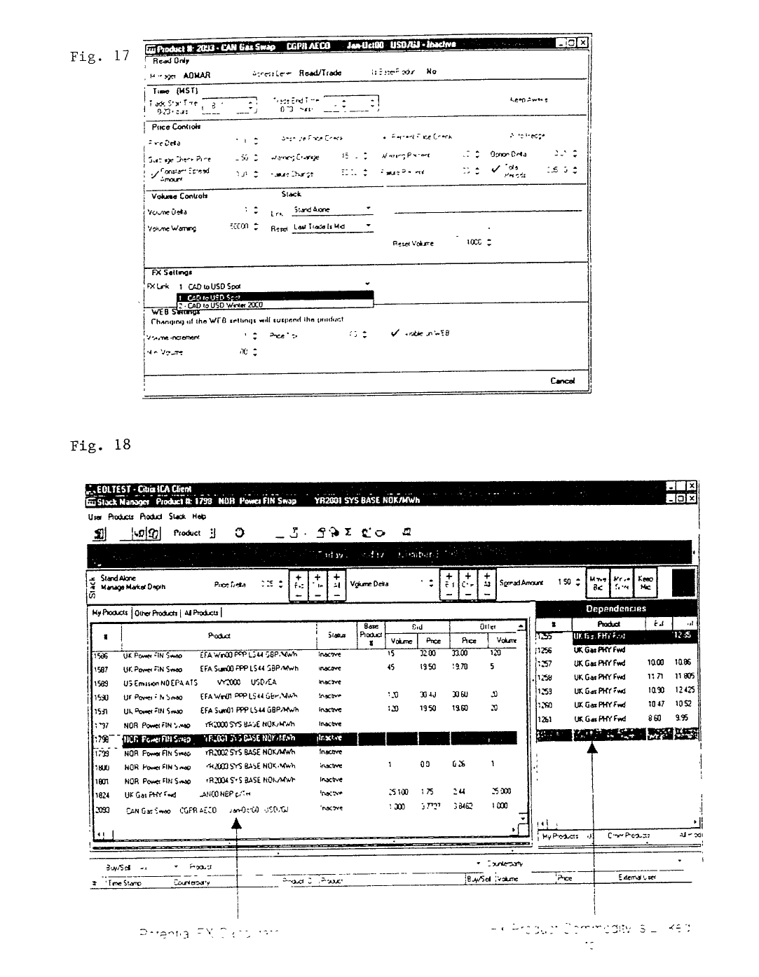

FIGS. 17 and 18 illustrate screens that can be used to implement a foreign exchange link, and the following is an example of an FX transaction. Assume that the product is a sale by the Party (and a purchase by the Counterparty) of Canadian gas for delivery in February 2000 at AECO which typically trades in Canadian dollars, but in this case specifies U.S. dollars as the currency, and assume that the FX manager has a foreign exchange product converting U.S. dollars to Canadian dollars in February 2000 as follows:

Foreign Exchange Product: USD<-->CAD FEB00

| Buy USD | Sell USD |
|---|---|
| 10,000,000 USD @ 1.41 | 10,000,000 USD @ 1.42 |
| CAD/USD | CAD/USD |

Physical product offering:

| | Bid | | Offer | Offer |
|---|---|---|---|---|
| Product | Vol | Bid Price | Price | Vol |
| CAD PHY Fwd FIRM AECO | 10000 | 1.5563 | 1.5745 | 10000 |
| FEB00 USD/GJ | | | | |

The stack manager would display the prices in Canadian currency, or the underlying currency; the foreign exchange manager converts those prices to the “offered in” currency and displays the as-converted price on the website to potential Counterparties.

Product Stack: CAD PHY Fwd Firm FEB00 gas at AECO in USD/GJ

Currency linked to USD<-->CAD FEB00

| Bid | | Offer | |
|---|---|---|---|
| Volume | Price | Volume | Price |
| 10000 | 2.21 | 10000 | 2.22 |
| 10000 | 2.19 | 10000 | 2.24 |

Assume that the counterparty clicks on the Party's offer price for 5,000 units of the above Canadian gas product. There are two transactions. One transaction is the commodity transaction in the underlying currency of the commodity. In the above example this would be a sale of 5000 units of natural gas by the Party to XYZ Energy as illustrated below.

| Product | Vol | Price | External User |
|---|---|---|---|
| CAD PHY Fwd AECO FEB00 USD/GJ | 5000 | 1.5745 | XYZ Energy |

The other transaction is in the FX exchange. In this example this would be a sale of U.S. dollars and be shown in stack manager as illustrated below.

| Product | Vol | Price |
|---|---|---|
| CAD/USD FEB00 | 320,442 | 1.41 |

When setting up a FX exchange product, a tolerance level should be specified for the product. The tolerance level specifies the minimum amount of FX product that must be made available at all times. If the quanity of the FX product falls below the tolerance level then the FX product will be automatically suspended, and the commodity stacks to which the FX product is linked will also be automatically inactivated. Consider an average trade size as 10,000 for CAD PHY Fwd FIRMAECO FEB00 USD/GJ. If one takes an average CAD/USD rate of 1.40 and a price of 1.56 USD/GJ then the total CAD required for one trade is:

10,000*29 days*1.40(FX rate)*1.56 (commodity price)=642,408.

Therefore for this product the FX tolerance quantity should be set at a minimum of C$650,000 and the quantity offered through the stack manager should be for 10,000 GJ. An FX trader should maintain a quantity of the FX exchange product that is at least two or three times a multiple of the tolerance quantity as this will allow a couple of trades to occur before having to replenish the quantity level

Where the bid and offer quantity for the FX product is greater than the tolerance quantity, the FX product will remain active regardless of the volume offered on the underlying commodity product. In this case where the bid and offer quantities on the website are greater than the bid or offer quantity in the FX exchange product, then the customer's transaction will fail because there is insufficient FX exchange product available to cover the transaction. For this reason one should ensure that the tolerance quantity and the average or normal trade size are always in approximate correlation with each other.

Performing Credit Checks. The system also provides for a means of ascertaining that a Counterparty has credit available with the Party in an amount sufficient to complete the transaction presented by the offer. While the system can be adapted to accommodate other means of settlement, or payment for, transactions entered into via the website, the current embodiment assumes that the Party and Counterparty have made some type of arrangements for the extension of credit between them to permit execution of transactions without immediate or simultaneous payment. Even in this event, however, because the system is largely automated, the total dollar volume of transactions entered into with any particular counterparty could easily involve substantial sums of money exceeding the level of credit that a party is willing to extend to even the most creditworthy counterparty if there were no means of monitoring the total amount of a party's trading volume via the website and suspending trading activity if the counterparty exceeded established credit limits. The system thus provides a means for determining the Party's credit exposure on a proposed transaction, monitoring the Party's overall credit exposure to a particular counterparty, and failing to complete transactions that would result in a counterparty exceeding their available credit with the Party.

Turning now to FIG. 19, a Party can calculate and attempt to minimize risk due to extending credit to a Counterparty. While numerous methods exist for determining the amount of credit that may be extended to a Counterparty, in the current embodiment the amount of available credit is determined by comparing a Party's aggregate credit exposure to the Counterparty, assuming completion of the transaction that has been offered, to the Counterparty's credit limit that has been established by the Party. The amount of a Party's credit exposure to a Counterparty may also be determined using a variety of methods; the method referred to in FIG. 19 takes into account “sigma factors,” or a statistical measure of the one-day volatility in prices of the products in which the Counterparty is transacting to determine the Party's credit exposure to a Counterparty. Regardless of the method used to determine a Party's credit exposure to a Counterparty, however, a Counterparty's credit exposure is preferably updated at the end of each trading session and new credit limits are established for the next trading session to properly monitor credit exposure to a particular Counterparty and to avoid incurring excessive credit exposure. Similarly, the aggregate amount of credit that should be extended to a Counterparty may be determined through numerous methods, but again, should be reviewed and updated daily.

Step 124 illustrates the Party calculating its credit exposure to a Counterparty on a requested deal using sigma factors; the credit exposure on a new deal can be added to the total credit extended thus far over a time period, such as one day (step 126). The credit extended thus far in a trading period is a total credit exposure, step 128, and available credit “headroom” is determined as the total credit that will be extended to the Counterparty minus the accumulated credit exposure. In step 128, the total current credit exposure is compared to the available credit headroom; if the available credit headroom is exceeded upon completion of a proposed transaction submitted by a Counterparty, then the system rejects the Counterparty's offer to enter into the transaction (step 130).

If there would be credit headroom available upon completion of a proposed transaction, the system will accept the proposed transaction and record it in a database in step 132, subject to the other validations previously described. The customer's transaction history is updated with the new transaction in step 134, and the stack manager updates the quotes screen to reflect the next available bid and offer prices and associated volumes (step 136). The customer's available headroom is also updated to reflect the completed transaction (step 138).

Turning to FIG. 20, an overview of one possible configuration of hardware is illustrated, according to the present invention. This illustrated configuration represents a multi-tier approach to hardware and software deployment for a publicly accessible internet site.

Various customers or counterparties have internet access through internet service providers 142a, 142b, and 142c. They access the site via browser-based software. Access to the site could be protected through a firewall 144 which would restrict access to only the resources the site is willing to make available. The area of the site between the firewall 144 and internal application servers 150 of the site is commonly referred to as the “DMZ” or “demilitarized-zone”.

Behind the firewall 144 is a bank of web servers 148 which provide the HTTP/HTML interface to the site. This bank can be divided into two partitions: servers 148a which handle real-time traffic and servers 148b which handle non-real-time traffic. A network load-balancing device 146 could be used to disperse the incoming traffic across the servers within the banks.

The above distinction of traffic into real-time and non-real-time traffic is made to allow more efficient use of hardware. The real-time traffic is the data that represents changes in products (e.g., price, volume, status) that are communicated to the customers or counterparties. The non-real-time traffic is all other data traffic through the web site. The non-real-time traffic is user initiated while the real-time traffic is made available to the browser without requiring any user interaction.

The web servers 148 communicate with application servers 150 across another firewall. This firewall would restrict the traffic to only the specified servers. The application servers 150 could be divided into two partitions 150a and 150b to mirror the web server partitions 148a and 148b. The application servers 150 would provide access to a database 152 where the data about the various products, counterparties, etc. would be maintained.

Applications such as stack manager, product manager, FX manager and data manager 154 and 156 would also connect to the database 152. These applications would be used to create and maintain data in the database. Changes made via these applications would then be communicated back to the user or counterparties via the application servers 150 and web servers 148.

In summary, a method is provided in which a Party can buy products from Counterparties and can sell products to Counterparties over a computer network, such as the Internet or a proprietary network. A Party determines bid and offer prices at which the Party is willing to buy or sell a product, and creates a marketplace for that product on the computer network by displaying to potential Counterparties a single bid and offer price and an associated volume, quantity or amount. Counterparties can view the bid and offer price that the Party transmits, and can send a signal, typically by clicking on a submission button, offering to buy or sell the product. Through the use of the computer system and software described herein, the party performs automated checks on the offer submitted by the counterparty, including checks on the availability of the requested price and volume, whether the Counterparty has agreed to the terms and conditions that will govern the transaction in the product, and whether the Party is willing to extend credit to the Counterparty. If the automated checks are passed, the Counterparty's offer is automatically accepted, which completes the transaction. Physical delivery and acceptance of the product follows subsequently.

The stack manager software described herein provides the Party with a mechanism for managing different bid and offer prices for a product. A Party can determine bid and offer prices (and associated volumes) for a trading period such as a day; activate the stack manager to display the best bid and offer price available at any particular time to potential Counterparties; and execute hundreds of transactions in an automatic mode, without a need for personal contact between the Party and the Counterparty to negotiate, execute, and document each and every trade. The trading efficiency of the Party is consequently much higher than the traditional method of personal contact for each and every trade, because the trader can manage an overall trading strategy and have time to obtain and analyze information as a market for a product changes throughout a trading day.

The system is also beneficial for Counterparties in that each Counterparty has an available market for buying or selling products on an essentially “real-time” and commission-free basis. If a Counterparty encounters a situation where the Counterparty needs to sell, the Party stands in a position to buy the product. On the other hand, if the Counterparty encounters a situation where the Counterparty needs to buy, the Party is ready and willing to sell. There is, however, a spread between the bid and offer prices at which the Party is willing to buy or sell, which makes the exchange economically feasible for the Party. Thus, an efficient trading method and system is provided. A marketplace for goods and services is created where buyers and sellers are in direct contact, and where at least one Party is willing to buy or sell.

While the present invention has been shown and described in particular and alternative embodiments, those skilled in the art will recognize from the foregoing discussion that various changes, modifications and variations may be made thereto without departing from the spirit and scope of the invention as set forth in the claims. Hence, the specific embodiments and any specific components and the like are merely illustrative and do not limit the scope of the invention or the claims herein.

1. A method for a party to buy and sell goods and/or services from and to a plurality of counterparties over a computer network, which comprises:
determining a bid price and an offer price at which the party is willing to buy or sell, respectively, a good or service;
providing the determined bid price and offer price for the good or service to the plurality of counterparties over the computer network;
receiving a signal from a counterparty over the computer network; and
buying the good or service from or selling the good or service to the counterparty upon receipt of the signal, wherein there is no requirement to pay a commission to a third party based on this purchase or sale of the good or service.

2. The method of claim 1, further comprising:
maintaining a list of determined bid prices and offer prices, wherein the determined bid price and offer price that is provided is from the list; and
after completing the transaction with the counterparty, providing the next determined bid price and offer price that is on the list so that a next determined bid price and offer price is displayed to the plurality of counterparties nearly immediately.

3. The method of claim 2, wherein a stack manager software is used to maintain the list of determined bid and offer prices, and wherein the stack manager software provides an interface and capability to the party for creating, viewing and editing the list of determined bid prices and offer prices and associating a volume or quantity for each determined bid price and offer price for each good and/or service.

4. The method of claim 3, wherein the stack manager software is capable of linking the list of determined bid prices and offer prices for one good or service with the list of determined bid prices and offer prices for another good or service, further comprising changing the determined bid prices and offer prices for one good or service in response to changes in the determined bid prices and offer prices for another good or service.

5. The method of claim 4, wherein the link is a basis link such that a first good or service serves as a basis for a second good or service, and wherein a constant difference is maintained between the first and second as the price of the first good or service changes.

6. The method of claim 5, further comprising completing transaction in the second good or service after completing a transaction in the first good or service.

7. The method of claim 4, wherein the stack manager software is capable of providing a syncopated link between first and second lists of determined bid prices and offer prices, where a first list of determined bid prices and offer prices for a good or service is linked with a second list of determined bid prices and offer prices for the same good or service, and wherein a transaction occurring in the good or service from the first list for a fixed amount or quantity of the good or service causes an equal change in the amount or quantity in the good or service in the second list.

8. The method of claim 7, further comprising linking the first list of determined bid prices and offer prices for the good or service to the determined bid price and offer price for a base good or service, wherein the price of the base good or service serves as a basis for the bid price or offer price in the first list of determined bid prices and offer prices.

9. The method of claim 1, further comprising:
after completing the transaction with the counterparty at a first determined bid price or offer price, providing a second determined bid price and offer price, wherein a spread is maintained between the bid and offer prices, and wherein the first determined bid or offer price becomes the midpoint of the spread between the second determined bid and offer price.

10. The method of claim 1, further comprising:
after completing the transaction with the counterparty at a first determined bid price or offer price, providing a second determined bid price and offer price, wherein a spread is maintained between the bid and offer prices, and wherein the second determined bid or offer price is set relative to the first determined bid or offer price plus or minus an offset.

11. The method of claim 1, further comprising:
maintaining a list of determined bid prices and offer prices in a stack manager software, wherein the determined bid price and offer price that is provided is from the list, and wherein an underlying currency and an offered currency are each associated with the bid and offer price for a good or service, further comprising linking the bid and offer price for a good or service that has the underlying currency and the offered currency to a foreign exchange manager software, and converting the value of the underlying currency to the offered currency using the foreign exchange manager software.

12. The method of claim 11, wherein changes in the relative value of the underlying currency and the offered currency are compensated for in the conversion of the value of the underlying currency to the offered currency.

13. The method of claim 1, wherein a counterparty may establish an acceptable price range so that if a determined bid price and offer price becomes unavailable during transmission of the signal, a transaction can still occur if a next determined bid price and offer price is within the acceptable price range.

14. The method of claim 1, further comprising determining a market risk for a good or service associated with price volatility for the good or service, and further comprising the party limiting trading with a counterparty to an amount of credit that the party is willing to extend to the counterparty.

15. The method of claim 1, further comprising determining and monitoring a credit limit for each of the plurality of counterparties, and further comprising suspending trade with a counterparty whose credit limit has been reached.

16. The method of claim 15, further comprising determining and monitoring an available headroom for each of the plurality of counterparties, the available headroom being the credit limit minus accumulated credit exposure.

17. The method of claim 1, wherein a contractual framework between the party and a counterparty for transacting in one or more goods or services is determined by an agreement, wherein the party requires an authorized signature for the counterparty on only a single-sheet document.

18. The method of claim 17, wherein the single-sheet document is a password application, and wherein the agreement includes the terms of an electronic trading agreement that is displayed through the computer network.

19. The method of claim 18, wherein the agreement further includes terms and conditions for each good or service bought or sold, further comprising transmitting and displaying the terms and conditions to the plurality of counterparties.

20. The method of claim 1, wherein each good and/or service is defined by attributes, the attributes including a product type.

21. The method of claim 20, wherein the product type includes a designation of at least two parameters selected from the group consisting of country, commodity, deal category, deal type, and firmness.

22. The method of claim 21, wherein the attributes include a reference period and a unit price.

23. The method of claim 22, wherein additional attributes can be selected to identify a good of service, and wherein the additional attributes are selected from the group consisting of a calendar identification, a location, an index, a load shape, a grid level, an option type and a strike price.

24. The method of claim 23, further comprising adding a product to the goods and/or services using a product manager software, wherein the product manager software is used for identifying a product by designating its attributes.

25. The method of claim 1, wherein the signal transmitted by the counterparty is encrypted for maintaining security of transactions, and wherein the signal is decrypted by the party.

26. The method of claim 25, wherein a secure socket layer software is used for the encryption.

27. The method of claim 1, wherein the determined bid price and offer price is pushed from the party's computer system to the counterparty's computer system over the computer network, and wherein the determined bid price and offer price is updated on a counterparty's computer monitor without intervention by the counterparty.

28. The method of claim 27, wherein the determined bid and offer prices are updated and/or displayed using streaming video technology.

29. The method of claim 1, wherein a single determined bid and offer price is displayed for a good or service on a take-it-or-leave-it basis, and wherein a transaction is completed at the single determined bid or offer price without negotiation.

30. A method for buying and selling goods and/or services over a computer network, comprising the steps of:
providing a display over a computer network accessible by a plurality of customers;
maintaining a list of bids and offers to buy or sell a good or service, wherein the list is maintained using a stack manager software;
displaying on the display the bid to buy the good or service and the offer to sell the good or service;
receiving a signal over the computer network from a customer;
buying or selling the good or service over the computer network in response to the signal from the customer; and
replacing the displayed bid and offer with a second bid and offer automatically by computerized steps after the step of buying or selling the good or service.

31. The method of claim 30, wherein the step of replacing the displayed bid and offer with the second bid and offer is accomplished by pushing the second bid and offer out over the computer network to the display.

32. The method of claim 30, wherein a quantity is specified for the particular good or service, and wherein the second bid and offer is adjusted before being displayed so that the price of a prior trade becomes the midpoint of the price between the bid and offer for a next trade.

33. The method of claim 30, wherein a quantity is specified for the particular good or service, and wherein the second bid and offer is adjusted before being displayed so that the bid or offer of a prior trade plus an offset becomes the price for the bid or offer, respectively, for a next trade.

34. The method of claim 30, further comprising establishing a list of bids, offers and quantities with a spread between each bid and offer for the good or service prior to the beginning of a trading session, and loading the list into the stack manager software prior to the beginning of the trading session, wherein the step of automatically replacing the displayed bid and offer with the second bid and offer is accomplished by displaying the next bid and offer on the list after the displayed bid and offer is satisfied.

35. A method for a party to buy and sell goods and/or services from and to a plurality of counterparties over a network of computers, comprising the steps of:
maintaining an electronic marketplace for buying and selling the goods and services, the electronic marketplace comprising the network of computers;
determining a bid price and an offer price at which the party is willing to buy or sell, respectively, a good or service;
transmitting and displaying the determined bid price and offer price for the good or service over the network of computers to the plurality of counterparties;
sending a signal from a counterparty to the party over the network of computers; and
buying the good or service from or selling the good or service to the counterparty over the network of computers in response to the signal, wherein the party is a principal in all trades, and wherein multiple counterparties can buy and/or sell goods and/or services in the electronic marketplace in transactions with the party, but the counterparties cannot enter into transactions with each other or with third parties in the electronic marketplace.

36. The method of claim 35, wherein the signal from a counterparty is an offer to buy or sell, further comprising:
determining a credit limit for each counterparty; and
evaluating a counterparty's offer to buy using a software adapted for such purpose to determine whether accepting the offer would exceed the counterparty's credit limit and not accepting the counterparty's offer if the counterparty's credit limit would otherwise be exceeded.

37. The method of claim 36, wherein there is no requirement to pay a commission to a third party.

38. The method of claim 37, wherein transactions are completed at the determined bid price or offer price for the good or service, without negotiation.

39. The method of claim 35, wherein transactions are completed at the determined bid price or offer price for the good or service, without negotiation, and wherein each good and/or service is defined by attributes, the attributes including a product type.

40. The method of claim 39, wherein the product type includes a designation of at least two parameters selected from the group consisting of country, commodity, deal category, deal type, and firmness.

41. The method of claim 35, further comprising:
maintaining a list of determined bid prices and offer prices in a stack manager software, wherein the determined bid price and offer price that is transmitted and displayed is from the list; and
after completing a transaction with a first counterparty, transmitting and displaying a next-determined bid price and offer price that is on the list, wherein the party uses the stack manager software to build, edit and maintain the list of determined bid prices and offer prices, each bid and offer having an associated volume, quantity or amount, and wherein the counterparties can see only one bid and offer price for each good and service.

42. The method of claim 41, wherein the stack manager software is capable of linking the list of determined bid prices and offer prices for one good or service with the list of determined bid prices and offer prices for another good or service, further comprising determining the determined bid price and offer price for the first good or service in response to changes in determined bid prices and offer prices for a second good or service.

43. The method of claim 41, further comprising resetting the next-determined bid price and offer price that is on the list as a function of the bid or offer price of an immediately prior transaction.

44. A computer readable program storage device encoded with instructions that, when executed by a computer, performs a method for buying and selling goods and/or services over a computer network, comprising:
maintaining a list of determined bid and offer prices using a stack manager software module, wherein the stack manager software module allows a party to edit, view and control the list;
transmitting a best determined bid price and offer price for the good or service over the computer network to a plurality of counterparties, a quantity, amount or volume being associated with the best-determined bid price and offer price;
receiving a signal from a counterparty over the computer network
interpreting the signal as an offer to sell or an offer to buy a good or service;
evaluating the offer to buy to determine whether the counterparty's credit limit would be exceeded if the offer were accepted; and
buying the good or service from or selling the good or service to the counterparty at the best determined bid price and offer price, respectively, without human intervention.

45. The computer readable program storage device encoded with instructions that, when executed by a computer, performs the method described in claim 44, wherein the best determined bid price and offer price that is transmitted and displayed is from the top of the list, further comprising:
after completing the transaction with the counterparty, transmitting and displaying the next determined bid price and offer price that is on the list so that a next determined bid price and offer price is displayed to the plurality of counterparties nearly immediately, wherein the stack manager software provides an interface and capability to the party for creating, viewing and editing the list of determined bid prices and offer prices and associating a volume or quantity for each determined bid price and offer price for each good and/or service, and wherein the counterparties can see the best determined and offer bid price but not the next determined bid and offer price.

46. The computer readable program storage device encoded with instructions that, when executed by a computer, performs the method described in claim 44, wherein an underlying currency and an offered currency are each associated with the bid and offer price for a good or service, further comprising linking the bid and offer price for a good or service that has the underlying currency and the offered currency to a foreign exchange manager software, and converting the value of the underlying currency to the offered currency using the foreign exchange manager software.

47. A method for a party to buy and sell commodities from and to a plurality of counterparties over a computer network, the method comprising the steps of:
establishing a set of parameters for a plurality of products for standardizing each of the products so that the products can be bought and sold as fungible commodities;
transmitting the set of parameters to the counterparties over the computer network;
determining a bid price and an offer price for a quantity, volume or amount of each of the products;
standing ready to buy at the bid price or sell at the offer price each of the products;
communicating the determined bid price and offer price for each of the products to the plurality of counterparties over the computer network;
receiving an offer to sell at the determined offer price or an offer to buy at the determined bid price the determined quantity, volume or amount of one of the products from one of the counterparties;
using a computer software adapted to receive and evaluate whether to accept the offer; and
accepting the offer without human intervention.

48. The method of claim 47, wherein the counterparties can only buy from or sell to the party.

49. The method of claim 48, wherein no commission is paid to a third party on a transaction.

50. The method of claim 47, further comprising determining a bid price and an offer price for a product with reference to a hub, wherein the hub is a physical location.

51. The method of claim 47, further comprising establishing contract terms with each counterparty before a counterparty can make an offer, wherein a contractual framework between the party and a counterparty for transacting in one or more products is determined by the contract terms.

52. The method of claim 51, wherein the contract terms include a password application that the counterparty submits to the party in order to gain access to the computer network in which the determined bid price and offer price are provided, and wherein the password application incorporates the terms of a trading agreement.

53. The method of claim 52, wherein the trading agreement includes terms and conditions for each bought or sold, further comprising transmitting the trading agreement over the computer network.

54. The method of claim 47, wherein the computer network is the internet, and the party provides a website through which the counterparties can buy from or sell to the party, and wherein the counterparties cannot buy from or sell to each other, and the counterparties cannot buy from or sell to a third party.

55. The method of claim 47, further comprising evaluating the financial condition of a potential counterparty, wherein evaluating whether to accept an offer includes determining a credit risk in accepting an offer.

56. The method of claim 47, wherein the commodities include price-risk-management services for specific goods.

57. The method of claim 56, further comprising a first counterparty signaling over the computer network its acceptance of a swap in which the first counterparty and the party agree to a financial arrangement that effectively fixes the price for a good for a period of time, wherein money is exchanged between the first counterparty and the party as a part of the swap, but the good is not exchanged between the first counterparty and the party as a part of the swap.

58. The method of claim 57, further comprising a second counterparty signaling over the computer network its acceptance of a cap or floor in which the second counterparty and the party agree to a financial arrangement that sets a maximum or minimum price, respectively, for a good for a period of time for an amount or quantity of the good, wherein the second counterparty pays money to the party in exchange for the cap or floor.
